(19) United States
(12) Patent Application Publication
(10) Pub. No.: US 2026/0059495 A1
(43) Pub. Date: Feb. 26, 2026

(54) PAGING TECHNIQUES FOR WIRELESS DEVICES WITH MIXED CAPABILITIES

(71) Applicant: QUALCOMM Incorporated, San Diego, CA (US)

(72) Inventors: Jing LEI, San Diego, CA (US); Linhai HE, San Diego, CA (US); Ruiming ZHENG, Beijing (CN)

(21) Appl. No.: 19/106,169

(22) PCT Filed: Sep. 18, 2023
(86) PCT No.: PCT/CN2023/119312

§ 371 Date: Feb. 24, 2025

(30) Foreign Application Priority Data
Oct. 19, 2022 (WO) PCT/CN2022/126067

(51) Int. Cl. H04W 68/02; H04W 76/27; H04W 76/28

(52) U.S. Cl. CPC H04W 68/02; H04W 76/27; H04W 76/28

(57) ABSTRACT

Methods, systems, and devices for wireless communications are described in which a user equipment (UE) may monitor for one or more paging messages based on a paging early indication (PEI) and whether the UE operates according to a first bandwidth configuration or a second bandwidth configuration. A UE may decode a PEI and determine whether to monitor for one or more subsequent paging messages based on one or more fields of the PEI. The PEI may include one or more fields associated with different UE types, with the fields indicating one or more UE subgroup identifications that are to monitor for an associated paging message, where the different subgroup identifications are associated with different UE types.

### CROSS REFERENCE

The present Application is a 371 national stage filing of International PCT Application No. PCT/CN2023/119312 by Lei et al. entitled “PAGING TECHNIQUES FOR WIRELESS DEVICES WITH MIXED CAPABILITIES,” filed Sep. 18, 2023; and claims priority to International Application PCT/CN2022/126067 by Lei et al., entitled “PAGING TECHNIQUES FOR WIRELESS DEVICES WITH MIXED CAPABILITIES,” filed Oct. 19, 2022, each of which is assigned to the assignee hereof, and each of which is expressly incorporated by reference in its entirety herein.

### FIELD OF TECHNOLOGY

The following relates to wireless communications, including paging techniques for wireless devices with mixed capabilities.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some wireless communications systems, in order to reduce power consumption, a discontinuous reception (DRX) cycle may be configured at wireless devices in which the wireless devices transition between lower power states and higher power states at certain intervals. In some cases, while in a higher power state, a wireless device may monitor for paging messages that indicate that the device has information to be communicated, and the device may alter a timing for the higher power state based on the paging messages. Enhanced techniques for monitoring for such paging messages may help further reduce power consumption and enhance system efficiency.

### SUMMARY

The described techniques relate to improved methods, systems, devices, and apparatuses that support paging techniques for wireless devices with mixed capabilities. For example, the described techniques provide that a user equipment (UE) may monitor for one or more paging communications based on whether the UE operates according to a first bandwidth configuration or a second bandwidth configuration, where the first and second bandwidth configurations have different receive bandwidths for one or more of the paging communications. In accordance with some aspects, a network entity may transmit, and the UE may receive, in a discontinuous reception (DRX) cycle, control signaling that provides a paging early indication (PEI). The UE may decode the PEI and determine whether to monitor for one or more subsequent paging communications based on the PEI.

In some aspects, a single PEI may include one or more fields associated with different UE types, such that the PEI includes a first UE subgroup identification (ID) field for UE IDs or UE class IDs that can be signaled with the PEI, as well as one or more of a second UE subgroup ID field or a third UE subgroup ID field for UEs that operate using a reduced bandwidth (e.g., low-tier UEs). In some cases, the second UE subgroup ID field may indicate subgroup IDs that are assigned by a core network entity via non-access stratum (NAS) signaling. Additionally, or alternatively, the third UE subgroup ID field may indicate subgroup IDs that are assigned by a serving network entity of the UE. In some aspects, separate PEIs may be transmitted for different UE types. In some cases, the separate PEIs may be configured with separate control resource sets (CORESETs) associated with different UE types. In some cases, separate search space sets may be configured for different UE types, different RNTIs may be configured for different UE types, or different demodulation reference signals (DMRSs) or waveforms may be configured for different UE types.

In some further aspects, a PEI may include a status indication for each subgroup of two or more subgroups associated with a UE ID or UE class ID that is indicated in the PEI. In some cases, the status indication may be a two-bit status indication that indicates whether the associated paging message is for UEs having the first bandwidth configuration, the second bandwidth configuration, any bandwidth configuration, or for no UEs with the UE ID or UE class ID. In some further aspects, information may be included in the paging control channel transmission (e.g. a paging physical downlink control channel (PDCCH)) that provides a resource allocation for a paging message shared channel communication (e.g., a paging physical downlink shared channel (PDSCH)). In such cases, the paging control channel transmission may indicate the UE type(s) that are paged in the paging message, such as by using a two-bit status indication. A UE that is not indicated to monitor the shared channel for the paging message may terminate paging message decoding to save power.

### BRIEF DESCRIPTION OF THE DRAWINGS

FIG. 1 illustrates an example of a wireless communications system that supports paging techniques for wireless devices with mixed capabilities in accordance with one or more aspects of the present disclosure.

FIG. 2 illustrates an example of a portion of a wireless communications system that supports paging techniques for wireless devices with mixed capabilities in accordance with one or more aspects of the present disclosure.

FIGS. 3A and 3B illustrate examples of paging transmission schemes that supports paging techniques for wireless devices with mixed capabilities in accordance with one or more aspects of the present disclosure.

FIG. 4 illustrates an example of a paging transmission scheme that supports paging techniques for wireless devices with mixed capabilities in accordance with one or more aspects of the present disclosure.

FIG. 5 illustrates an example of a PEI structure that supports paging techniques for wireless devices with mixed capabilities in accordance with one or more aspects of the present disclosure.

FIG. 6 illustrates an example of a process flow that supports paging techniques for wireless devices with mixed capabilities in accordance with one or more aspects of the present disclosure.

FIG. 7 illustrates an example of a process flow that supports paging techniques for wireless devices with mixed capabilities in accordance with one or more aspects of the present disclosure.

FIG. 8 illustrates an example of a process flow that supports paging techniques for wireless devices with mixed capabilities in accordance with one or more aspects of the present disclosure.

FIGS. 9A and 9B illustrate examples of PEI resources that support paging techniques for wireless devices with mixed capabilities in accordance with one or more aspects of the present disclosure.

FIGS. 10 and 11 illustrate block diagrams of devices that support paging techniques for wireless devices with mixed capabilities in accordance with one or more aspects of the present disclosure.

FIG. 12 illustrates a block diagram of a communications manager that supports paging techniques for wireless devices with mixed capabilities in accordance with one or more aspects of the present disclosure.

FIG. 13 illustrates a diagram of a system including a device that supports paging techniques for wireless devices with mixed capabilities in accordance with one or more aspects of the present disclosure.

FIGS. 14 and 15 illustrate block diagrams of devices that support paging techniques for wireless devices with mixed capabilities in accordance with one or more aspects of the present disclosure.

FIG. 16 illustrates a block diagram of a communications manager that supports paging techniques for wireless devices with mixed capabilities in accordance with one or more aspects of the present disclosure.

FIG. 17 illustrates a diagram of a system including a device that supports paging techniques for wireless devices with mixed capabilities in accordance with one or more aspects of the present disclosure.

FIGS. 18 through 26 illustrate flowcharts showing methods that support paging techniques for wireless devices with mixed capabilities in accordance with one or more aspects of the present disclosure.

### DETAILED DESCRIPTION

In the course of wireless communications, a network entity may communicate to a user equipment (UE) that a paging message is to be delivered to the UE in a paging occasion (PO) associated with a discontinuous reception (DRX) cycle. Such paging messages may be used to notify a UE that is in an idle or inactive mode of incoming data. To notify the UE of such a paging message, paging early indication (PEI) fields may be used in control signaling to indicate a paging occasion (PO) during which the UE may receive the paging message. Additionally, or alternatively, a UE in such an idle mode may also monitor for short messages (e.g., system information messages, emergency notifications, or both). Such short messages may be included in further control signaling that schedules the paging messages. Further, in some deployments different types of UEs may be present, including a first type of UEs that operate according to a first bandwidth configuration in which paging control channel messages (e.g., paging physical downlink control channel (PDCCH) messages) and paging shared channel messages (e.g., paging physical downlink shared channel (PDSCH) messages) are both transmitted using a first downlink bandwidth (e.g., a 20 MHz downlink bandwidth), and a second type of UEs that operate according to a second bandwidth configuration in which paging control channel messages are transmitted using the first downlink channel bandwidth (e.g., 20 MHz downlink bandwidth) and paging shared channel messages are transmitted using a second downlink bandwidth (e.g., a 5 MHz downlink bandwidth). The second type of UEs may include, for example, reduced capability (RedCap) UEs that are relatively low complexity and are lower cost devices.

In cases where multiple different types of UEs are present, one or more paging messages (e.g., paging PDSCH messages) may be transmitted using a downlink bandwidth that corresponds to the lower supported downlink bandwidth of one or more device types. For example, if a second type of UE operates using a 5 MHz downlink bandwidth for paging PDSCH messages, at least some of the paging PDSCH messages may be transmitted using the 5 MHz downlink bandwidth. However, a reduced bandwidth relative to a first type of UE that operates using a 20 MHz bandwidth for all paging messages may result in fewer UEs that are able to be paged in a particular DRX cycle. Thus, in situations where a relatively large number of UEs are to be paged, some UEs may have to wait for multiple DRX cycles to receive a page. For example, a UE may transition to a higher power consumption state of a DRX cycle to monitor for a page and, due to the relatively low bandwidth of paging messages, may actually receive the paging message in a subsequent DRX cycle that is one or more DRX cycles after an initial DRX cycle that corresponds to when the page could have been transmitted if a larger downlink bandwidth were used. In such cases, the UE wakes up and monitors for a paging PDCCH in each DRX cycle, which consumes power at the UE and increases latency for communications. Further, if the UE is capable of monitoring for PEIs, the UE may skip monitoring and decoding of some POs based on the PEI indication. However, existing PEI signaling does not provide for an indication related to a type of UE that is being paged in cases where multiple different types of UEs are present. Thus, even when implementing PEI techniques, deployments that use multiple types of UEs with multiple different bandwidth configurations may result in increased power consumption by some UEs.

In accordance with various aspects discussed herein, to reduce or eliminate such shortcomings of other approaches, a UE may receive control signaling that includes PEI fields that may be associated with a PO, and that may indicate whether a UE of a particular bandwidth configuration is to monitor for paging messages in the associated PO. In some aspects, a UE may monitor for one or more paging communications based on whether the UE operates according to a first bandwidth configuration or a second bandwidth configuration, where the first and second bandwidth configurations have different receive bandwidths for one or more of the paging communications (e.g., a 20 MHz downlink bandwidth for paging PDSCH for the first bandwidth configuration and a 5 MHz downlink bandwidth for paging PDSCH for the second bandwidth configuration). In accordance with some aspects, a network entity may transmit, and the UE may receive, in a DRX cycle, control signaling that provides a PEI. The UE may decode the PEI and determine whether to monitor for one or more subsequent paging communications based on the PEI.

In some aspects, a PEI may include one or more fields associated with different UE types, such that the PEI includes a first UE subgroup identification (ID) field for UE IDs or UE class IDs that can be signaled with the PEI, as well as one or more of a second UE subgroup ID field or a third UE subgroup ID field for UEs that operate using a reduced bandwidth (e.g., low-tier UEs or RedCap UEs). In some cases, the second UE subgroup ID field may indicate subgroup IDs that are assigned by a core network entity via non-access stratum (NAS) signaling. Additionally, or alternatively, the third UE subgroup ID field may indicate subgroup IDs that are assigned by a serving network entity of the UE.

In some other aspects, separate PEIs may be transmitted for different UE types. In some cases, the separate PEIs may be configured with separate control resource sets (CORESETs) associated with different UE types. In some cases, separate search space sets may be configured for different UE types, different RNTIs may be configured for different UE types, or different demodulation reference signals (DMRSs) or waveforms may be configured for different UE types.

In some further aspects, a PEI may include a status indication for each subgroup of two or more subgroups associated with a UE ID or UE class ID that is indicated in the PEI. In some cases, the status indication may be a two-bit status indication that indicates whether the associated paging message is for UEs having the first bandwidth configuration, the second bandwidth configuration, any bandwidth configuration, or for no UEs with the UE ID or UE class ID. In some further aspects, information may be included in the paging control channel transmission (e.g. a paging PDCCH) that provides a resource allocation for a paging message shared channel communication (e.g., a paging PDSCH). In such cases, the paging control channel transmission may indicate the UE type(s) that are paged in the paging message, such as by using a two-bit status indication. A UE that is not indicated to monitor the shared channel for the paging message may terminate paging message decoding to save power.

The approaches described herein provide various benefits to wireless communications, including reduced power consumption due to shorter wakeup times, reduced latency due to improved timing of paging messages, and precise indication of when a short message is to be received by a UE. Further, techniques discussed herein may provide for reduced consumption of processing resources (e.g., due to fewer blind decoding operations), which may provide enhanced system efficiency and enhanced user experience.

Aspects of the disclosure are initially described in the context of wireless communications systems. Aspects of the disclosure are then described in connection with exemplary paging transmission schemes, control signaling schemes, and process flows. Aspects of the disclosure are further illustrated by and described with reference to apparatus diagrams, system diagrams, and flowcharts that relate to paging techniques for wireless devices with mixed capabilities.

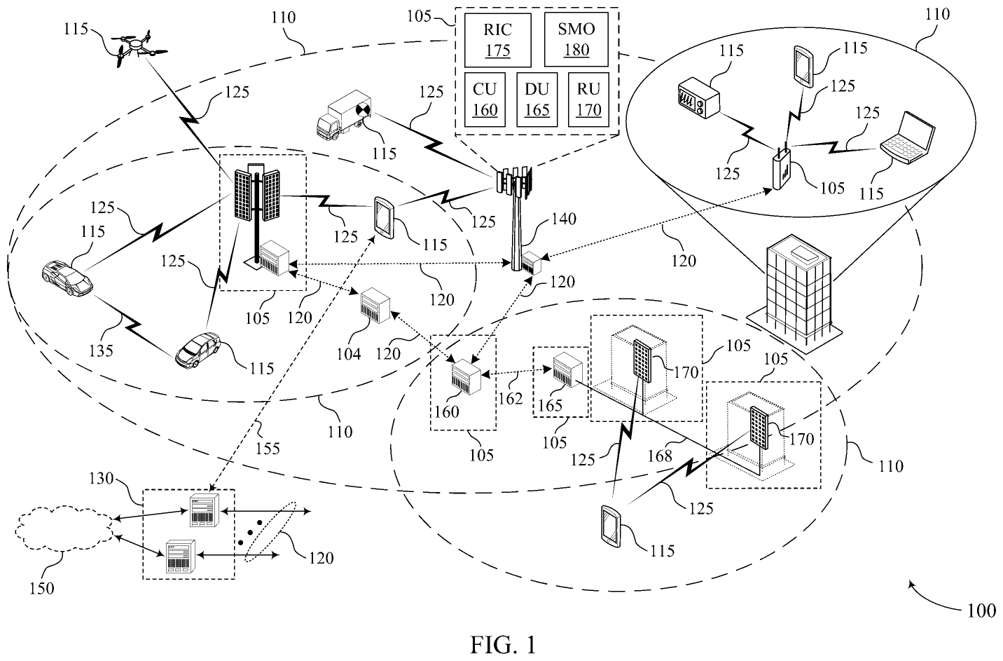

FIG. 1 illustrates an example of a wireless communications system 100 that supports paging techniques for wireless devices with mixed capabilities in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support paging techniques for wireless devices with mixed capabilities as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some implementations a UE 115 may receive (e.g., from a network entity 105) control signaling that may include one or more PEIs. Such PEIs may be associated with notifying the UE 115 that the UE 115 is to receive one or more paging messages. In some aspects, the UE 115 may monitor for one or more paging messages based on a PEI and whether the UE operates according to a first bandwidth configuration or a second bandwidth configuration, where the first and second bandwidth configurations have different receive bandwidths for one or more of the paging messages. In accordance with some aspects, the UE 115 may decode a PEI transmitted in a PEI occasion of a DRX cycle and determine whether to monitor for one or more subsequent paging communications based on one or more fields of the PEI. In some cases, a single PEI may include one or more fields associated with different UE types, such that the PEI includes a first UE subgroup ID field for UE IDs or UE class IDs that can be signaled with the PEI, as well as one or more of a second UE subgroup ID field or a third UE subgroup ID field for UEs that are an associated type of UE (e.g., a low-tier UE). In some cases, the second UE subgroup ID field may indicate subgroup IDs that are assigned by a core network entity (e.g., a CU 160 or DU 165) via NAS signaling. Additionally, or alternatively, the third UE subgroup ID field may indicate subgroup IDs that are assigned by a serving network entity (e.g., a RU 170, a RIC 175, or a base station 140) of the UE 115. In some aspects, separate PEIs may be transmitted for different UE types. In some cases, the separate PEIs may be configured with separate CORESETs associated with different UE types. In some cases, separate search space sets may be configured for different UE types, different RNTIs may be configured for different UE types, or different DMRSs or waveforms may be configured for different UE types.

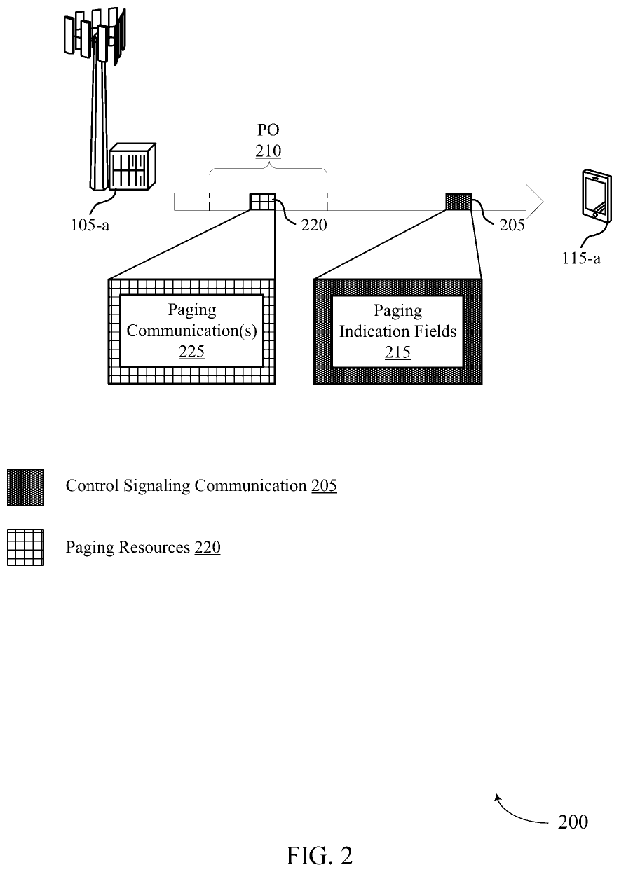

FIG. 2 illustrates an example of a wireless communications system 200 that supports paging techniques for wireless devices with mixed capabilities in accordance with one or more aspects of the present disclosure. The wireless communications system 200 may include network entity 105-a that may be an example of one or more network entities discussed in relation to other figures. The wireless communications system 200 may include a UE 115-b that may be an example of UEs discussed in relation to other figures.

As discussed herein, in the course of wireless communications, a network entity 105-a may have data that is to be transmitted to the UE 115-a. However, due to power saving modes or other circumstances, the UE 115-a may not be in an active mode to receive the data. As such, the network entity 105-a may transmit a paging message to the UE 115-a during a PO of a DRX cycle to indicate to the UE 115-a that there is data waiting for the UE 115-a or that the UE 115-a is to perform some other action with the wireless communications network. In some cases, the network entity 105-a may notify the UE 115-a of a paging message that is to be received through the use of a PEI. Such a PEI, which may be an example of a control signaling communication 205, may indicate to the UE 115-a that the UE 115-a is to receive a paging message in one or more POs 210.

In some cases, a PEI may indicate multiple POs (e.g., up to eight POs or another quantity of POs) such as the PO 210. Further, a PEI may indicate one or more paging subgroups that may be associated with a paging message within a PO such as the PO 210. In some examples, a single PO may have multiple paging subgroups (e.g., up to eight paging subgroups or another quantity of paging subgroups).

The network entity 105-a may transmit the PEI to the UE 115-a via first control signaling 205 (e.g., DCI). The PEI may be indicated via one or more PEI fields 215 included in the first control signaling 205. For example, the PEI may include one or more paging indication fields that are mapped to one or more subgroups of UEs, the one or more subgroups of UEs including a first set of paging subgroups configured for a first type of UE that supports a first receive bandwidth configuration (e.g., with a 20 MHz downlink bandwidth for paging PDSCH messages) and a second set of paging subgroups configured for a second type of UE that supports a second receive bandwidth configuration (e.g., with a 5 MHz downlink bandwidth for paging PDSCH messages) that is different than the first receive bandwidth configuration. Based on the PEI, the UE 115-a may monitor the paging resources 220 of the PO 210 for one or more paging communications 225 (e.g., a paging PDCCH, a paging PDSCH).

In some cases, one or more PEI fields may be associated with subgroup IDs that are assigned by a core network entity via NAS signaling. Additionally, or alternatively, one or more PEI fields may indicate subgroup IDs that are assigned by a serving network entity such as network entity 105-a. In some other aspects, separate PEIs may be transmitted for different UE types. In such cases, the separate PEIs may be configured with separate control resource sets (CORESETs) associated with different UE types. Additionally, or alternatively, separate search space sets may be configured for different UE types, different RNTIs may be configured for different UE types, or different DMRSs or waveforms may be configured for different UE types.

In some further aspects, a PEI may include a status indication for each subgroup of two or more subgroups associated with a UE ID or UE class ID that is indicated in the PEI. In some cases, the status indication may be a two-bit status indication that indicates whether the associated paging message is for UEs having the first bandwidth configuration, the second bandwidth configuration, any bandwidth configuration, or for no UEs with the UE ID or UE class ID. In some further aspects, information may be included in the paging control channel transmission (e.g. a paging PDCCH) that provides a resource allocation for a paging message shared channel communication (e.g., a paging PDSCH). In such cases, the paging control channel transmission may indicate the UE type(s) that are paged in the paging message, such as by using a two-bit status indication as discussed above. In cases where the UE 115-a is not indicated to monitor the shared channel for the paging message, the UE 115-a may terminate paging message decoding to save power.

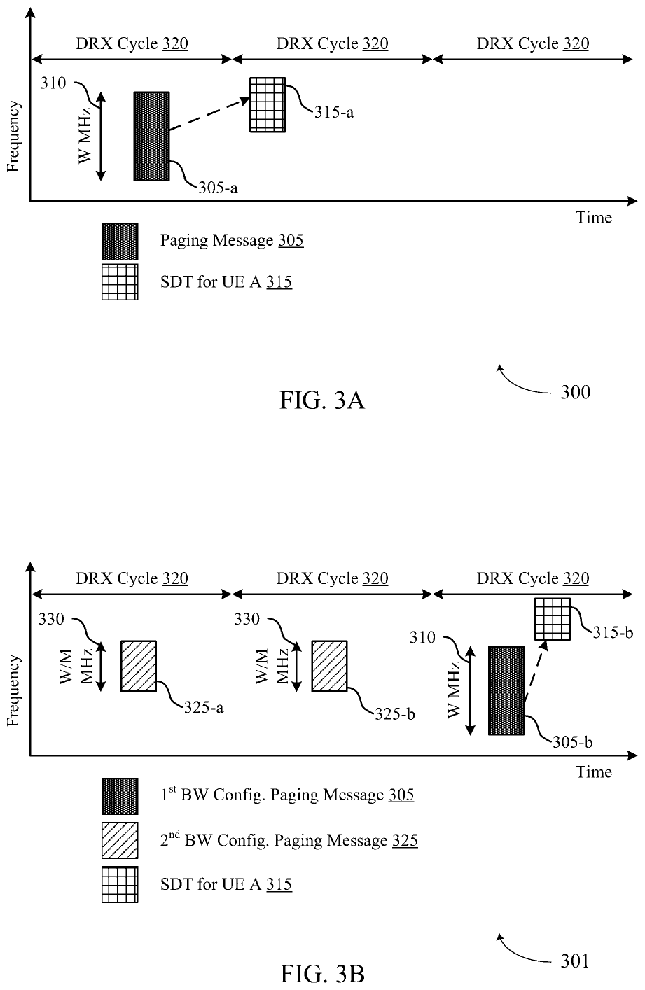

FIGS. 3A and 3B illustrate examples of paging transmission schemes 300 and 301 that support paging techniques for wireless devices with mixed capabilities in accordance with one or more aspects of the present disclosure. The paging transmission schemes 300 and 301 may implement or be implemented by one or more aspects of the wireless communications system 100 or the wireless communications system 200. For example, the paging transmission schemes 300 and 301 may be implemented by a UE 115 or a network entity 105, which may be examples of the corresponding devices as described with reference to FIGS. 1 and 2. In the example of FIGS. 3A and 3B, the network entity 105 may be an example of a CU, a DU, an RU, a base station, an IAB node, or one or more other network nodes as described with reference to FIG. 1.

In the example of FIG. 3A, a first paging message 305-a may be transmitted in a DRX cycle 320 using a first downlink bandwidth 310 (e.g., W MHz). In the examples of FIGS. 3A and 3B, paging messages 305 may have the first downlink bandwidth 310 that corresponds to a legacy/premium UE that is a larger bandwidth than for a low-tier or RedCap UE. In some cases, the first downlink bandwidth 310 may be a 20 MHz bandwidth (e.g., W=20). In some cases, the first paging message 305-a may include an indication for a small data transmission (SDT) 315-a for a UE (e.g., UE A). As discussed herein, in some deployments that implement the example of FIG. 3A, all UEs may support a receive bandwidth of up to W MHz for paging. In such cases, up to L paging records may be multiplexed in paging message 305-a. Thus, if there are L UEs being paged (including UE A configured with mobile terminated (MT) SDT), all UEs can receive paging by the end of a single DRX cycle.

In the example of FIG. 3B, multiple different UE types may be present, and a network entity may transmit paging messages 325 having a second bandwidth configuration that use a second downlink bandwidth 330 that is different than the first downlink bandwidth 310. In some cases, the second downlink bandwidth 330 may be W/M MHz, where M is greater than one. For example, the second downlink bandwidth 330 may be 5 MHz (e.g., W=20 and M=4). Further, UEs that support a larger downlink bandwidth corresponding to first downlink bandwidth may be present, and may receive paging message(s) 305, such as a UE that receives second paging message 305-b in a third DRX cycle 320 in FIG. 3B. Similarly as discussed with reference to FIG. 3A, in some cases, the second paging message 305-b may include an indication for a SDT 315-b for a UE (e.g., UE A).

Thus, in the example of FIG. 3B, different DRX cycles may provide paging resources for different UE types. As discussed, due to the lower bandwidth of the paging messages 325 (e.g. paging message 325-a of a first DRX cycle 320 and paging message 325-b of a second DRX cycle 320), even if there are less than L UEs being paged as in the example of FIG. 3A, UE A may need to monitor POs on multiple DRX cycles and receive SDT 315-b at a later time than the SDT 315-a is received in the example of FIG. 3A. In cases where operation is in accordance with traditional paging and PEI techniques, UE A may spend more power and experience longer latency in the example of FIG. 3B, even though there may be fewer UEs being paged in the example of FIG. 3B than in the example of FIG. 3A. This can result in increased power consumption (e.g., due to additional time in the higher power state and performing blind decoding of paging control signaling transmitted via PDCCH that indicates paging resources for the paging messages). As discussed, even in cases where PEI may be implemented, existing PEI does not provide for indications of UE types (e.g. RedCap/low-tier or non-RedCap/premium UEs) that should monitor for paging messages. Thus, further enhancements to PEI such as discussed herein may help reduce power consumption in systems where multiple different types of UEs are present. Thus, in accordance with various aspects discussed herein, efficiency of UE A may be enhanced by signaling to the UE that it may transition to a lower power mode for the first two DRX cycles 320 in the example of FIG. 3B.

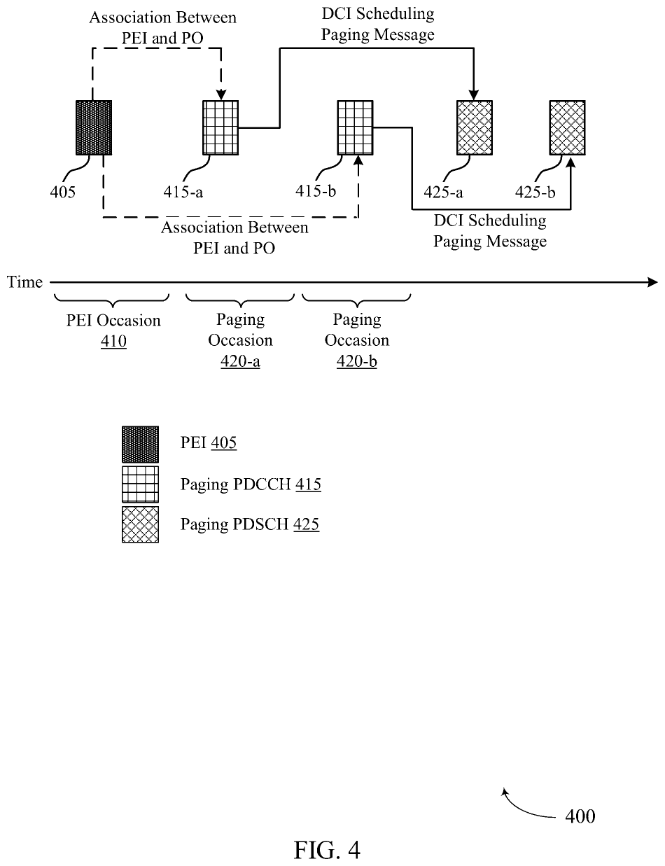

FIG. 4 illustrates an example of a paging transmission scheme 400 that supports paging techniques for wireless devices with mixed capabilities in accordance with one or more aspects of the present disclosure. The paging transmission scheme 400 may implement or be implemented by one or more aspects of the wireless communications system 100 or the wireless communications system 200. For example, the paging transmission scheme 400 may be implemented by a UE 115 or a network entity 105, which may be examples of the corresponding devices as described with reference to FIGS. 1 and 2. In the example of FIG. 4, the network entity 105 may be an example of a CU, a DU, an RU, a base station, an IAB node, or one or more other network nodes as described with reference to FIG. 1.

In the example of FIG. 4, a PEI 405 may be transmitted in a PEI occasion 410 and may provide an indication for one or more subgroup IDs that are to monitor for a paging message. For example a first set of UEs may be configured with a first subgroup ID (e.g., via RRC signaling and/or other signaling such as a MAC control element (MAC-CE) or downlink control information (DCI)), and a second set of UEs may be configured with a second subgroup ID (e.g., via RRC signaling, MAC-CE, and/or DCI). If the PEI 405 indicates the first subgroup ID, the second set of UEs, upon decoding the PEI 405, may discontinue monitoring for further paging communications in the associated DRX period. In this example, UEs of the first set of UEs, based on the first subgroup ID in the PEI 405, may monitor for a paging PDCCH 415. In some cases, different POs 420 may be associated with the PEI 405, such as a first PO 420-a that may provide a first paging PDCCH 415-a, and a second PO 420-b that may provide a second paging PDCCH 415-b. The PEI 405 may be carried by a PDCCH transmitted on the PEI occasion 410, where PEI occasions 410 may be configured as part of system information, for example. In some cases, such as in the example of FIG. 4, one PEI 405 may be associated with multiple POs 420, although in other examples a single PO 420 may be associated with the PEI 405.

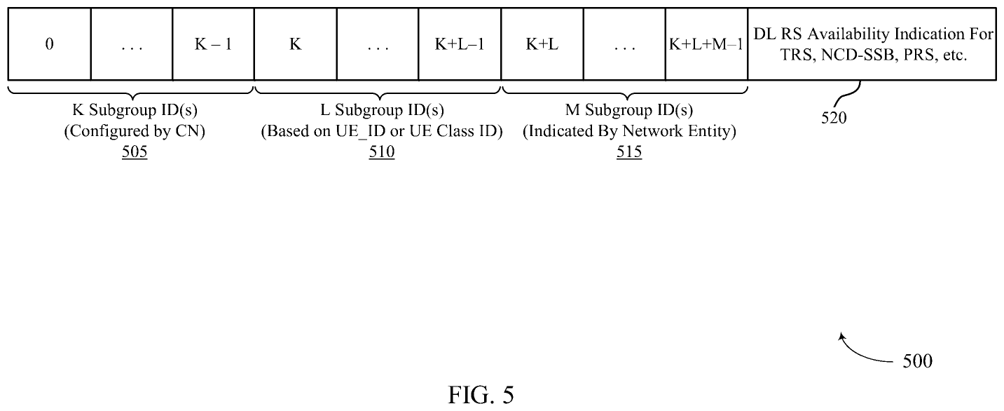

A paging message such as paging PDSCH 425 may be scheduled by the paging PDCCH 415. In this example, the first paging PDCCH 415-a may provide a DCI that includes scheduling information for first paging PDSCH 425-a, and the second paging PDCCH 415-b may provide a DCI that includes scheduling information for second paging PDSCH 425-b. As discussed, if PEI 405 is supported by both the network entity and UEs, any UEs not indicated in the PEI 405 may skip decoding both the paging PDCCH 415 and paging PDSCH 425. As discussed herein, in some cases the PEI 405 may include one or more paging indication fields that are mapped to one or more subgroups of UEs, including a first set of paging subgroups configured for a first type of UE that supports a first receive bandwidth configuration and a second set of paging subgroups configured for a second type of UE that supports a second receive bandwidth configuration that is different than the first receive bandwidth configuration. In such cases, a UE may determine to monitor or skip monitoring POs 420 based on a bandwidth configuration of the UE. Examples of PEI fields and associated operations for determining whether to monitor or skip monitoring for paging messages are discussed in more detail with reference to FIGS. 5 through 9.

In some cases, PEI may not be supported by either the network entity or UE. In such cases, a UE may need to decode a paging PDCCH 415 (e.g., by monitoring PO 420). In accordance with some aspects discussed herein, such UEs may still skip decoding a paging PDSCH 425 based on an indication in the paging PDCCH 415. In some cases, the network entity may include supplementary information in a paging PDCCH 415, to indicate if the paging message (e.g., paging PDCSH 425) includes paging records for a single UE type, or mixed UE types, so that a UE may terminate paging PDSCH 25 decoding earlier to save power. In some cases, the paging PDCCH 415 may include a two-bit indicator to indicate the contents of the paging message, such as:
01: paging message is for premium/legacy UE only;
10: paging message is for low-tier UE only;
11: paging message is for all UE types;
00: no UEs in the subgroup are paged on the next paging cycle.
   Using such a technique, a UE may decode a paging PDCCH 415 and determine whether or not to decode the associated paging PDSCH 425, which may reduce power consumption and reduce an amount of processing resources used for decoding operations.

FIG. 5 illustrates an example of a PEI structure 500 that supports paging techniques for wireless devices with mixed capabilities in accordance with one or more aspects of the present disclosure. The PEI structure 500 may implement or be implemented by one or more aspects of the wireless communications system 100 or the wireless communications system 200. For example, the PEI structure 500 may be implemented by a UE 115 or a network entity 105, which may be examples of the corresponding devices as described with reference to FIGS. 1 and 2. In the example of FIG. 5, the network entity 105 may be an example of a CU, a DU, an RU, a base station, an IAB node, or one or more other network nodes as described with reference to FIG. 1.

As discussed herein, in accordance with various aspects, UEs may be configured with PEI subgrouping based on UE capability. In some cases, when different UE types co-exist in a network supporting PEI, subgroup IDs may be configured in a PEI based on UE capabilities, where the PEI is shared by different UE types. In some cases, for low-tier UEs supporting core network controlled subgrouping for PEI, a first set of subgroup IDs 505 of PEI dedicated to low-tier UEs may be included in PEI structure 500 (e.g. as a first PEI field). In some cases, IDs associated with the first set of subgroup IDs 505 may be assigned by a core network entity (e.g., a CU or DU) via NAS signaling. The first set of subgroup IDs 505 may support K subgroup IDs such as by using a bit field where a bit indicates a zero if the associated subgroup ID is not activated for monitoring for paging messages and indicates a one if the associated subgroup ID is activated for monitoring for paging messages. In some cases, the UEs may be RRC configured with an associated subgroup ID of a first set of subgroups IDs 505. The group of activated fields or bits may be associated with one or multiple POs, which may also be RRC configured, configured in system information (e.g., in one or more system information blocks (SIBs)), or any combinations thereof.

In the example of FIG. 5, an additional set of subgroup IDs 510 may be included in PEI structure 500 (e.g., as a second PEI field), corresponding to PEI subgroup IDs based on a UE ID or UE class ID. In this example, this set of subgroup IDs 510 may include up to L subgroup IDs, and thus includes L bits in the PEI structure. While various examples discussed herein use a bitmap structure where a bit in the associated PEI field indicates whether the associated subgroup ID is active or not, other examples may use other addressing techniques to identify subgroup IDs, such as a mapping of one or more subgroups to a bit value of an associated field, for example.

Additionally, or alternatively, in some cases a network entity such as a base station, RU, and/or RIC, may be PEI-capable and may allow mixed UE types to camp on a cell that is served by the network entity. In such cases, the network entity may configure subgroups of IDs in a second set of subgroup IDs 515 (e.g., indicated in a third PEI field). In some cases, one or more subgroup IDs of PEI dedicated to low-tier UEs may be configured by the network entity and be broadcast in system information (SI) to served UEs. In some cases, a PEI-capable network entity that allow low-tier UEs to camp may provide a cell-specific or RAN notification area (RNA) specific set of numbers common to low-tier UEs (e.g., UE Class ID) that may be broadcast in SI, which is used by low-tier UEs to determine the PO index and the subgroup ID in the second set of subgroup IDs 515 of the PEI structure 500. In some cases, within a paging message, a temporary mobile subscriber identity (TMSI), such as a 5G-S-TMSI, may be used by the network entity to identify different UEs having a same capability. Thus, the PEI structure 500 includes multiple paging indication fields that are mapped to multiple corresponding subgroups of UEs, the subgroups UEs including a first set of paging subgroups configured for a first type of UE that supports a first receive bandwidth configuration (e.g., corresponding to one or more subgroup IDs of the first set of subgroup IDs 505 or the second set of subgroup IDs 515) and a second set of paging subgroups configured for a second type of UE that supports a second receive bandwidth configuration (e.g., corresponding to one or more subgroup IDs of the first set of subgroup IDs 505 or the second set of subgroup IDs 515 that are not in the first set of paging subgroups) that is different than the first receive bandwidth configuration.

Additionally, or alternatively, in some aspects a downlink reference signal availability indication 520 may be provided in the PEI structure 500. Such a downlink reference signal availability indication 520 may indicate one or more reference signals, such as a tracking reference signal (TRS), a non-cell-defining synchronization signal block (NCD-SSB), a positioning reference signal (PRS), or any combinations thereof, may be attached to the subgroup ID(s) indicated in the PEI structure 500 (e.g., that are available for UEs having a subgroup ID that is indicated in a set of subgroups configured by a core network entity, determined by UE_ID/UE class ID, indicated by a serving network entity, or any combinations thereof).

On some further aspects, PEI subgrouping or separate PEI transmission based on UE capability may not be supported by the network or a UE, and a network entity may still provide assistance information for UEs monitoring PEI. In some cases, for a PEI-capable UE, the network entity may signal additional information in a PEI that includes a field for only the set of subgroup IDs 510. In such cases, the PEI may have an augmented bit-width of the field mapped to each subgroup ID, or may have a mask or bitmap to indicate the status of paging subgroup identified by the subgroup ID (e.g., associated with low-tier UE) if the subgroup ID is associated with UEs that have different UE types (e.g., both premium and low-tier UEs are associated with a same subgroup ID). In some cases, the augmented bit-width may provide a two-bit indication (e.g., instead of a one-bit indication) for a status indication of each paging subgroup, where the two-bit indication may indicate the contents of the paging message, such as:
01: paging message is for premium/legacy UE only;
10: paging message is for low-tier UE only;
11: paging message is for all UE types;
00: no UEs in the subgroup are paged on the next paging cycle.

Using such a technique, a UE may decode a PEI and determine whether or not to monitor the associated PO(s), which may reduce power consumption and reduce an amount of processing resources used for decoding operations.

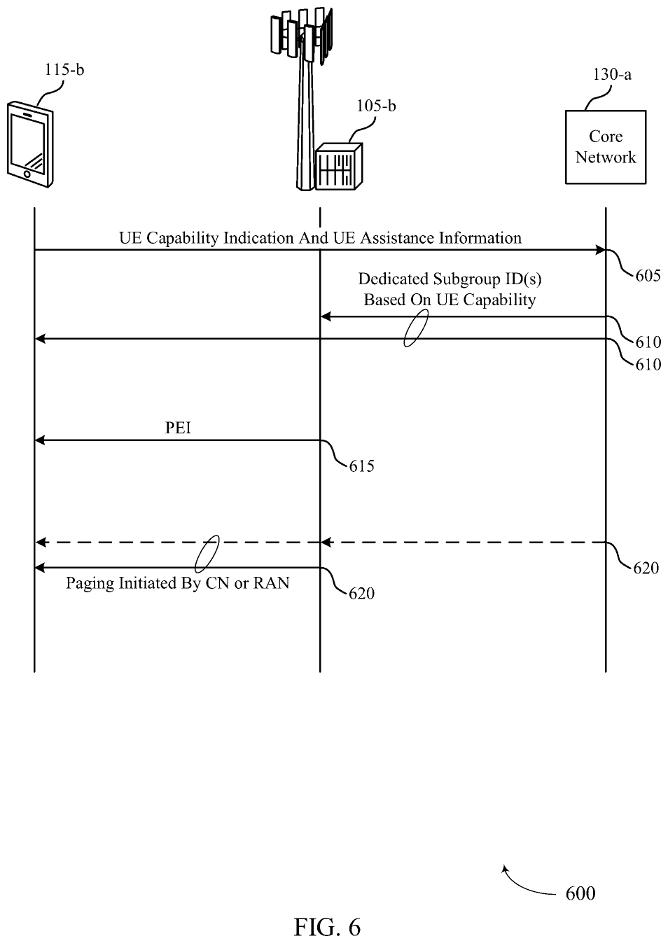

FIG. 6 illustrates an example of a process flow 600 that supports paging techniques for wireless devices with mixed capabilities in accordance with one or more aspects of the present disclosure. The process flow 600 may implement various aspects of the present disclosure described herein. The elements described in the process flow 600 (e.g., the UE 115-b, the network entity 105-b, core network 130-a) may be examples of similarly-named elements described herein.

In the following description of the process flow 600, the operations between the various entities or elements may be performed in different orders or at different times. Some operations may also be left out of the process flow 600, or other operations may be added. Although the various entities or elements are shown performing the operations of the process flow 600, some aspects of some operations may also be performed by other entities or elements of the process flow 600 or by entities or elements that are not depicted in the process flow, or any combination thereof.

At 605, the UE 115-b may transmit, and the network entity 105-b and core network 130-a may receive, a UE capability indication and UE assistance information. In some cases, the UE capability indication may indicate that the UE 115-b is a PEI-capable UE. Further, the UE capability indication may indicate that the UE 115-b is capable of enhanced PEI in which different sets of paging subgroups may be associated with different types of UEs (e.g., low-tier UEs configured for reduced shared channel downlink bandwidth relative to premium UEs that have larger shared channel downlink bandwidth).

At 610, the core network 130-a may provide an indication of dedicated subgroup ID(s) based on UE capability. In some cases, the dedicated subgroup ID(s) configured by the core network 130-a may be mapped to a first PEI field of a plurality of PEI fields, the first PEI field associated with a plurality of subgroup IDs, where different subgroup IDs may correspond to different UE types.

At 615, the network entity 105-b may transmit a PEI to the UE 115-b. The PEI may indicate to the UE 115-b whether a paging message for the UE 115-b is present in a PO that is associated with the PEI. In some cases, the PEI may be transmitted in a DRX cycle, and may be associated with a subsequent paging occasion configured for multiple different types of UEs, where the PEI comprises one or more paging indication fields that are mapped to one or more subgroups of UEs, the one or more subgroups of UEs including a first set of paging subgroups configured for a first type of UE that supports a first receive bandwidth configuration and a second set of paging subgroups configured for a second type of UE that supports a second receive bandwidth configuration that is different than the first receive bandwidth configuration. In some cases, the UE 115-b may determine whether or not to monitor a subsequent PO associated with the PEI based at least in part on whether a subgroup ID in the PEI is configured for a UE type of the first UE 115-b.

At 620, one or more paging messages may be transmitted by the network entity 105-b, or the core network 130-a via the network entity 105-b. The UE 115-b may monitor for the one or more paging messages based on the determination that was made based on the PEI and the associated subgroup ID of the UE 115-b.

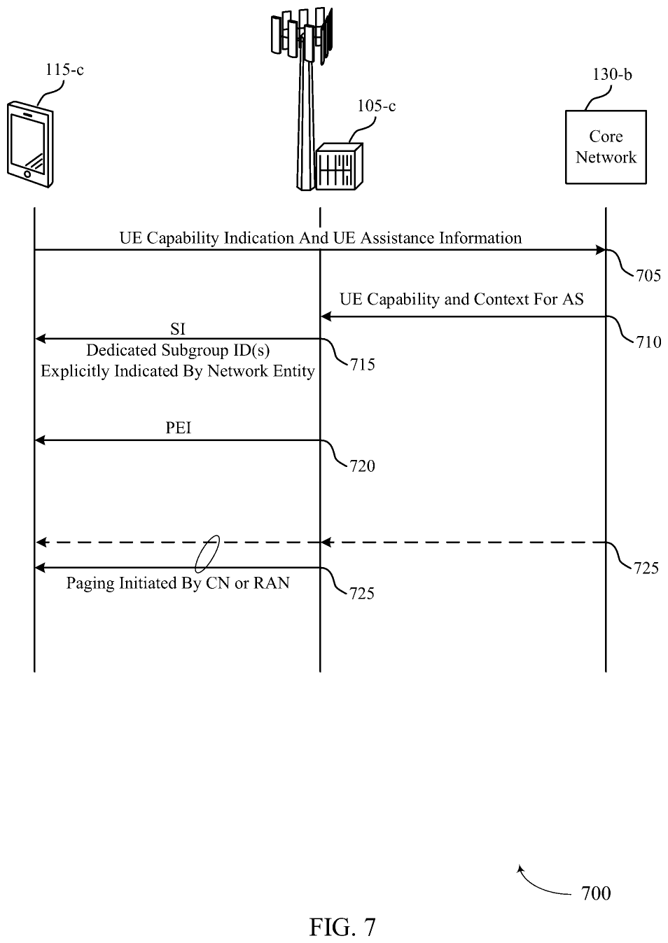

FIG. 7 illustrates an example of a process flow 700 that supports paging techniques for wireless devices with mixed capabilities in accordance with one or more aspects of the present disclosure. The process flow 700 may implement various aspects of the present disclosure described herein. The elements described in the process flow 700 (e.g., the UE 115-c, the network entity 105-c, core network 130-b) may be examples of similarly-named elements described herein.

In the following description of the process flow 700, the operations between the various entities or elements may be performed in different orders or at different times. Some operations may also be left out of the process flow 700, or other operations may be added. Although the various entities or elements are shown performing the operations of the process flow 700, some aspects of some operations may also be performed by other entities or elements of the process flow 700 or by entities or elements that are not depicted in the process flow, or any combination thereof.

At 705, the UE 115-c may transmit, and the network entity 105-c and core network 130-b may receive, a UE capability indication and UE assistance information. In some cases, the UE capability indication may indicate that the UE 115-c is a PEI-capable UE. Further, the UE capability indication may indicate that the UE 115-c is capable of enhanced PEI in which different sets of paging subgroups may be associated with different types of UEs (e.g., low-tier UEs configured for reduced shared channel downlink bandwidth relative to premium UEs that have larger shared channel downlink bandwidth).

At 710, the core network 130-b may provide an indication to the network entity 105-c of UE capability and context for access stratum communications. In some cases, capability may indicate that the UE 115-c is a PEI-capable UE and may indicate a UE type of the UE 115-c. In some cases, the core network 130-b may indicate that the network entity 105-c may configure subgroup IDs for PEIs associated with different UE types. The network entity 105-c may identify one or more subgroups of UEs and configure different subgroup IDs for different types of UEs.

At 715, the network entity 105-c may transmit system information (e.g. one or more SIBs) that indicates one or more dedicated subgroup IDs associate with different UE types. The different subgroup IDs may be explicitly indicated by the network entity 105-c such that a PEI that indicates different subgroup IDs may indicate to the UE 115-c whether or not to monitor one or more POs associated with the PEI.

At 720, the network entity 105-c may transmit a PEI to the UE 115-c. The PEI may indicate to the UE 115-c whether a paging message for the UE 115-c is present in a PO that is associated with the PEI. In some cases, the PEI may be transmitted in a DRX cycle, and may be associated with a subsequent paging occasion configured for multiple different types of UEs, where the PEI comprises one or more paging indication fields that are mapped to one or more subgroups of UEs, the one or more subgroups of UEs including a first set of paging subgroups configured for a first type of UE that supports a first receive bandwidth configuration and a second set of paging subgroups configured for a second type of UE that supports a second receive bandwidth configuration that is different than the first receive bandwidth configuration. In some cases, the UE 115-c may determine whether or not to monitor a subsequent PO associated with the PEI based at least in part on whether a subgroup ID in the PEI is configured for a UE type of the first UE 115-c.

At 725, one or more paging messages may be transmitted by the network entity 105-c, or the core network 130-b via the network entity 105-c. The UE 115-c may monitor for the one or more paging messages based on the determination that was made based on the PEI and the associated subgroup ID of the UE 115-c.

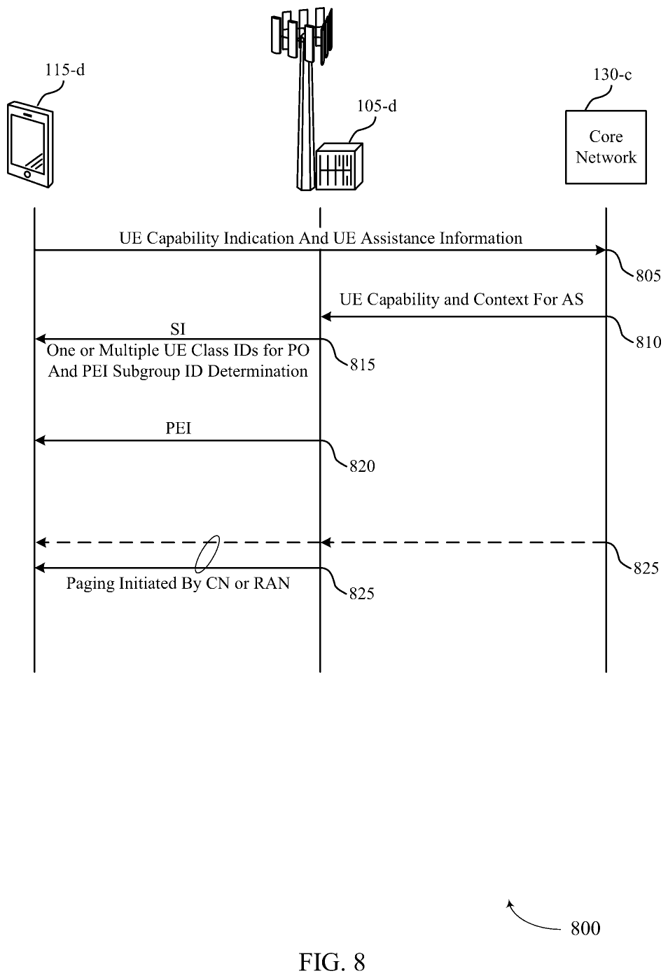

FIG. 8 illustrates an example of a process flow 800 that supports paging techniques for wireless devices with mixed capabilities in accordance with one or more aspects of the present disclosure. The process flow 800 may implement various aspects of the present disclosure described herein. The elements described in the process flow 800 (e.g., the UE 115-d, the network entity 105-d, core network 130-c) may be examples of similarly-named elements described herein.

In the following description of the process flow 800, the operations between the various entities or elements may be performed in different orders or at different times. Some operations may also be left out of the process flow 800, or other operations may be added. Although the various entities or elements are shown performing the operations of the process flow 800, some aspects of some operations may also be performed by other entities or elements of the process flow 800 or by entities or elements that are not depicted in the process flow, or any combination thereof.

At 805, the UE 115-d may transmit, and the network entity 105-d and core network 130-c may receive, a UE capability indication and UE assistance information. In some cases, the UE capability indication may indicate that the UE 115-d is a PEI-capable UE. Further, the UE capability indication may indicate that the UE 115-d is capable of enhanced PEI in which different sets of paging subgroups may be associated with different types of UEs (e.g., low-tier UEs configured for reduced shared channel downlink bandwidth relative to premium UEs that have larger shared channel downlink bandwidth).

At 810, the core network 130-c may provide an indication to the network entity 105-d of UE capability and context for access stratum communications. In some cases, capability may indicate that the UE 115-d is a PEI-capable UE and may indicate a UE type of the UE 115-d. In some cases, the core network 130-c may indicate that the network entity 105-d may configure subgroup IDs for PEIs associated with different UE types. The network entity 105-d may identify one or more subgroups of UEs and configure different subgroup IDs for different types of UEs.

At 815, the network entity 105-d may transmit system information (e.g. one or more SIBs) that indicates one or multiple UE class IDs for PO(s) and PEI subgroup ID determination. The different UE class IDs may be indicated by the network entity 105-d such that a PEI that indicates different subgroup IDs may indicate to the UE 115-d whether or not to monitor one or more POs associated with the PEI.

At 820, the network entity 105-d may transmit a PEI to the UE 115-d. The PEI may indicate to the UE 115-d whether a paging message for the UE 115-d is present in a PO that is associated with the PEI. In some cases, the PEI may be transmitted in a DRX cycle, and may be associated with a subsequent paging occasion configured for multiple different types of UEs, where the PEI comprises one or more paging indication fields that are mapped to one or more subgroups of UEs, the one or more subgroups of UEs including a first set of paging subgroups configured for a first type of UE that supports a first receive bandwidth configuration and a second set of paging subgroups configured for a second type of UE that supports a second receive bandwidth configuration that is different than the first receive bandwidth configuration. In some cases, the UE 115-d may determine whether or not to monitor a subsequent PO associated with the PEI based at least in part on whether a subgroup ID in the PEI is configured for a UE type of the first UE 115-d.

At 825, one or more paging messages may be transmitted by the network entity 105-d, or the core network 130-c via the network entity 105-d. The UE 115-d may monitor for the one or more paging messages based on the determination that was made based on the PEI and the associated subgroup ID of the UE 115-d.

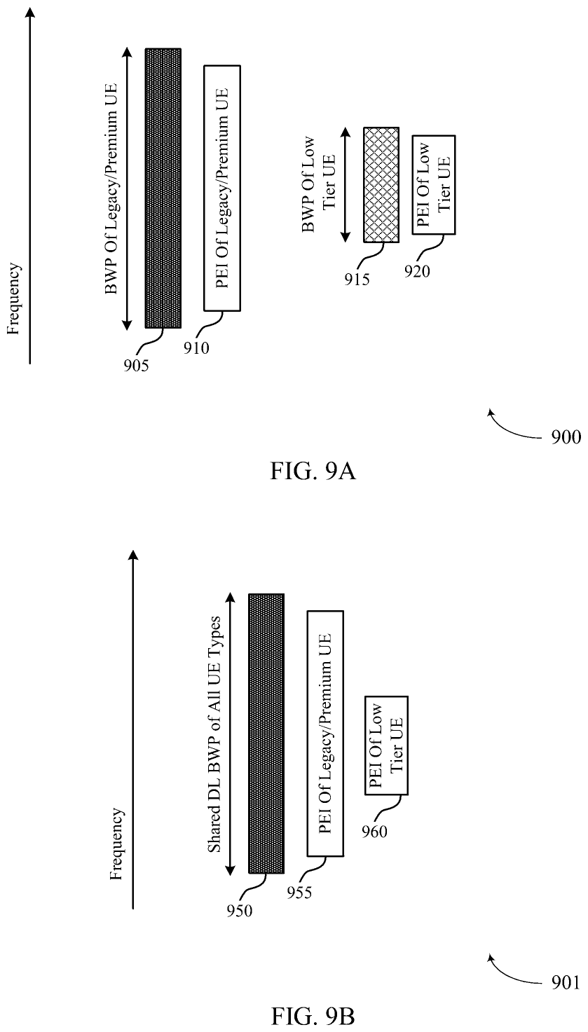

FIGS. 9A and 9B illustrate examples of PEI resources 900 and 901 that support paging techniques for wireless devices with mixed capabilities in accordance with one or more aspects of the present disclosure. The PEI resources 900 and 901 may implement or be implemented by one or more aspects of the wireless communications system 100 or the wireless communications system 200. For example, the PEI resources 900 and 901 may be implemented by a UE 115 or a network entity 105, which may be examples of the corresponding devices as described with reference to FIGS. 1 and 2. In the example of FIGS. 9A and 9B, the network entity 105 may be an example of a CU, a DU, an RU, a base station, an IAB node, or one or more other network nodes as described with reference to FIG. 1.

As discussed herein, in accordance with various aspects, UEs may be configured with PEIs based on UE capability. In some cases, when different UE types co-exist in a network supporting PEI, different PEIs may be configured PEI based on UE capabilities, where different PEIs are associated with different UE types. In some cases, such as illustrated in FIG. 9A, a separate CORESET for different PEIs may be provided. In such cases, a first downlink bandwidth 905 associated with a premium/legacy UE may be associated with a first CORESET and may be used for transmission of a PEI 910 for premium/legacy UEs. A second downlink bandwidth 915 may be associated with low-tier UEs may be associated with a second CORESET and may be used for transmission of a PEI 920 for low-tier UEs. In such cases, PEI 920 for low-tier UEs may be transmitted on a CORESET associated with a separately configured narrow-band downlink bandwidth part such as illustrated in FIG. 9A. In other cases, as illustrated in FIG. 9B, PEI 960 for low-tier UEs may be transmitted on a narrow-band CORESET that is nested within a shared downlink bandwidth part 950. In this example, PEI 955 associated with a premium/legacy UE may be transmitted using a larger bandwidth of the shared downlink bandwidth part 950.

In some cases, separate search space set configurations may be provided for PEI, where a different range of aggregation level (AL), or different time offset/periodicity/skipping rules for PDCCH monitoring may be configured for UEs having different UE types. In such cases, the different types of UEs may monitor for PEI based on the configured search space sets, and may decode associated PEI that indicates whether or not the UE is to monitor a PO or not. Additionally, or alternatively, different radio network temporary identifiers (RNTIs) may be used for different PEIs associated with different types of UEs. In such cases, a PEI for a low-tier UE may be scrambled by a group RNTI that is different from PEI-RNTI configured for legacy/premium UEs. Additionally, or alternatively, different DMRS or signal waveforms may be used for different PEIs associated with different types of UEs. For example, a DMRS transmitted with a PEI for a low-tier UE may be configured with different a scrambling ID, a different antenna port, or a different density/pattern for RE mapping than a PEI for a premium/legacy UE; or a sequence-based PEI can be configured for low-tier UEs.

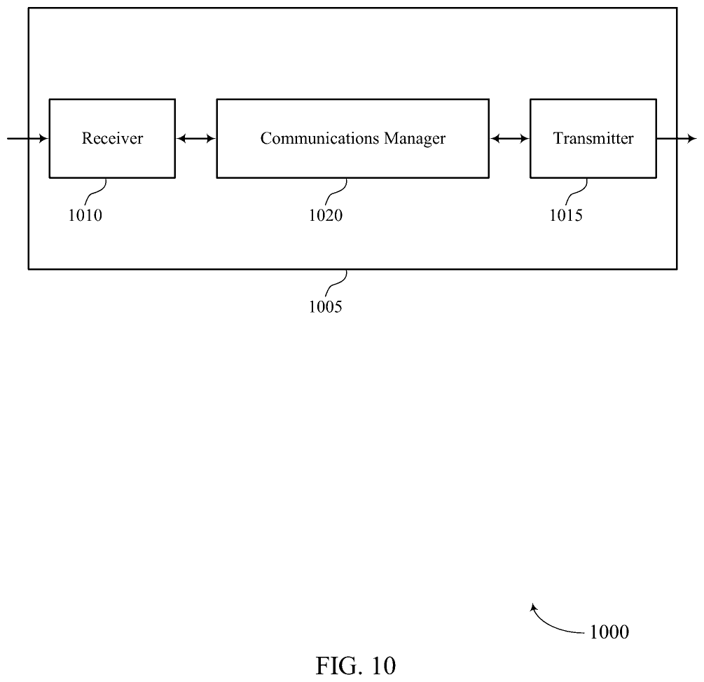

FIG. 10 illustrates a block diagram 1000 of a device 1005 that supports paging techniques for wireless devices with mixed capabilities in accordance with one or more aspects of the present disclosure. The device 1005 may be an example of aspects of a UE 115 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to paging techniques for wireless devices with mixed capabilities). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to paging techniques for wireless devices with mixed capabilities). In some examples, the transmitter 1015 may be co-located with a receiver 1010 in a transceiver module. The transmitter 1015 may utilize a single antenna or a set of multiple antennas.

The communications manager 1020, the receiver 1010, the transmitter 1015, or various combinations thereof or various components thereof may be examples of means for performing various aspects of paging techniques for wireless devices with mixed capabilities as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1020, the receiver 1010, the transmitter 1015, or various combinations or components thereof may be implemented in code (e.g., as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications at a first UE in accordance with examples as disclosed herein. For example, the communications manager 1020 may be configured as or otherwise support a means for receiving, in a DRX cycle, a control signaling communication for PEI associated with a subsequent PO configured for multiple different types of UEs, where the PEI includes one or more paging indication fields that are mapped to one or more subgroups of UEs, the one or more subgroups of UEs including a first set of paging subgroups configured for a first type of UE that supports a first receive bandwidth configuration and a second set of paging subgroups configured for a second type of UE that supports a second receive bandwidth configuration that is different than the first receive bandwidth configuration. The communications manager 1020 may be configured as or otherwise support a means for determining whether to monitor the subsequent PO associated with the PEI based on whether a subgroup ID in the PEI is configured for a UE type of the first UE.

By including or configuring the communications manager 1020 in accordance with examples as described herein, the device 1005 (e.g., a processor controlling or otherwise coupled with the receiver 1010, the transmitter 1015, the communications manager 1020, or a combination thereof) may support techniques for indicating whether a UE is to monitor for one or more paging messages, which may reduce power consumption due to shorter UE wakeup times, reduce latency due to improved timing of paging messages, and/or reduced consumption of processing resources due to fewer blind decoding operations, which may provide enhanced system efficiency and enhanced user experience.

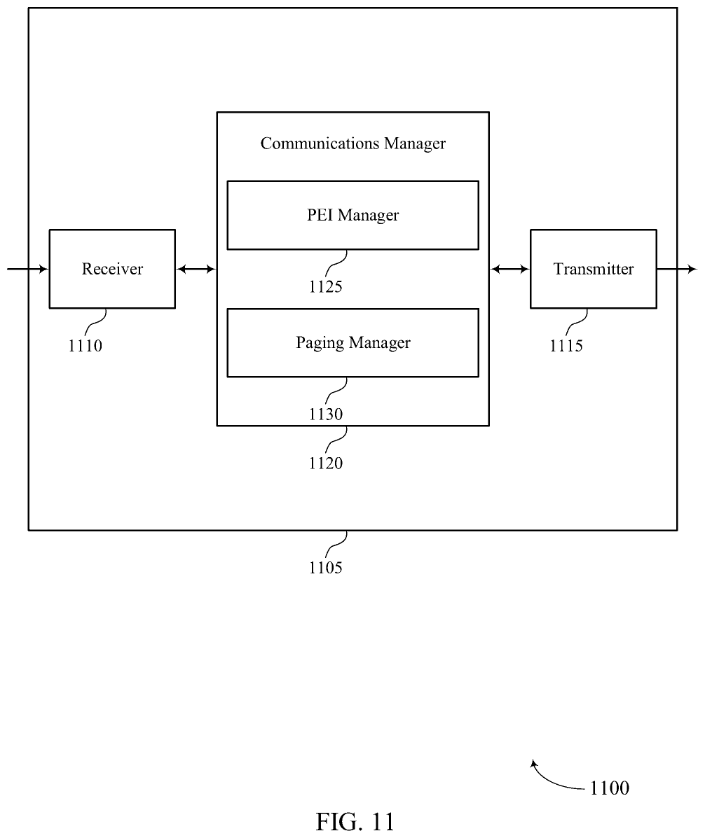

FIG. 11 illustrates a block diagram 1100 of a device 1105 that supports paging techniques for wireless devices with mixed capabilities in accordance with one or more aspects of the present disclosure. The device 1105 may be an example of aspects of a device 1005 or a UE 115 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for receiving information such as packets, user data, control information, or any combination thereof associated with various information channels (e.g., control channels, data channels, information channels related to paging techniques for wireless devices with mixed capabilities). Information may be passed on to other components of the device 1105. The receiver 1110 may utilize a single antenna or a set of multiple antennas.

The transmitter 1115 may provide a means for transmitting signals generated by other components of the device 1105. For example, the transmitter 1115 may transmit information such as packets, user data, control information, or any combination thereof associated with various information channels (e.g., control channels, data channels, information channels related to paging techniques for wireless devices with mixed capabilities). In some examples, the transmitter 1115 may be co-located with a receiver 1110 in a transceiver module. The transmitter 1115 may utilize a single antenna or a set of multiple antennas.

The device 1105, or various components thereof, may be an example of means for performing various aspects of paging techniques for wireless devices with mixed capabilities as described herein. For example, the communications manager 1120 may include a PEI manager 1125 a paging manager 1130, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications at a first UE in accordance with examples as disclosed herein. The PEI manager 1125 may be configured as or otherwise support a means for receiving, in a DRX cycle, a control signaling communication for PEI associated with a subsequent PO configured for multiple different types of UEs, where the PEI includes one or more paging indication fields that are mapped to one or more subgroups of UEs, the one or more subgroups of UEs including a first set of paging subgroups configured for a first type of UE that supports a first receive bandwidth configuration and a second set of paging subgroups configured for a second type of UE that supports a second receive bandwidth configuration that is different than the first receive bandwidth configuration. The paging manager 1130 may be configured as or otherwise support a means for determining whether to monitor the subsequent PO associated with the PEI based on whether a subgroup ID in the PEI is configured for a UE type of the first UE.

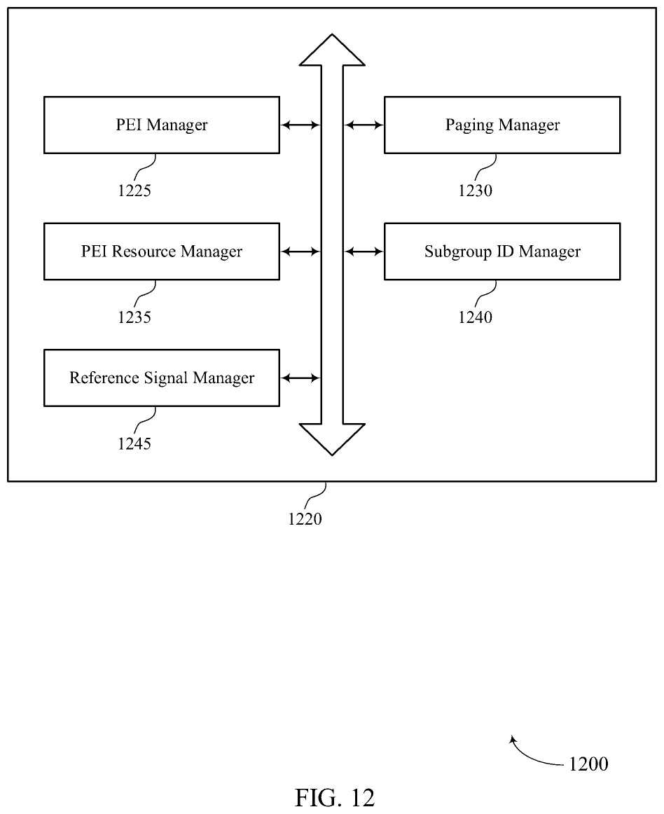

FIG. 12 illustrates a block diagram 1200 of a communications manager 1220 that supports paging techniques for wireless devices with mixed capabilities in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of paging techniques for wireless devices with mixed capabilities as described herein. For example, the communications manager 1220 may include a PEI manager 1225, a paging manager 1230, a PEI resource manager 1235, a subgroup ID manager 1240, a reference signal manager 1245, or any combination thereof. Each of these components may communicate, directly or indirectly, with one another (e.g., via one or more buses).

The communications manager 1220 may support wireless communications at a first UE in accordance with examples as disclosed herein. The PEI manager 1225 may be configured as or otherwise support a means for receiving, in a DRX cycle, a control signaling communication for PEI associated with a subsequent PO configured for multiple different types of UEs, where the PEI includes one or more paging indication fields that are mapped to one or more subgroups of UEs, the one or more subgroups of UEs including a first set of paging subgroups configured for a first type of UE that supports a first receive bandwidth configuration and a second set of paging subgroups configured for a second type of UE that supports a second receive bandwidth configuration that is different than the first receive bandwidth configuration. The paging manager 1230 may be configured as or otherwise support a means for determining whether to monitor the subsequent PO associated with the PEI based on whether a subgroup ID in the PEI is configured for a UE type of the first UE.

In some examples, the PEI manager 1225 may be configured as or otherwise support a means for receiving, in a subsequent DRX cycle, a subsequent control signaling communication for PEI associated with one or more subsequent POs configured for one or more multiple types of UEs. In some examples, the paging manager 1230 may be configured as or otherwise support a means for skipping monitoring one or more of the subsequent POs associated with the PEI based on a paging indication field indicating the subgroup ID configured for the UE type of the first UE will not be paged on the subsequent POs associated with the PEI.

In some examples, to support receiving the control signaling communication, the PEI manager 1225 may be configured as or otherwise support a means for receiving, in the DRX cycle, the PEI that includes a set of multiple Paging indication fields for multiple UE types which are allowed to monitor paging messages, short messages, system information, other control signaling of a serving network entity, or any combinations thereof. In some examples, each paging indication field of the set of multiple paging indication fields is associated with an identification of a set of different paging subgroup IDs, and indicates if UEs sharing a same subgroup ID will be paged on the subsequent POs associated with the PEI.

In some examples, the set of multiple paging indication fields include one or more of a first paging indication field, a second paging indication field, or a third paging indication field, where the first paging indication field provides a first set of subgroup IDs that are configured by a core network entity, the second paging indication field provides a second set of subgroup IDs that are associated with a UE ID or UE class ID, and the third paging indication field provides a third set of subgroup IDs that are configured at a serving cell belonging to a radio area network (RAN) notification area (RNA) of the UE. In some examples, first control signaling further indicates one or more downlink reference signals associated with the one or more subgroups of UEs are activated for UEs in IDLE or INACTIVE states. In some examples, the one or more downlink reference signals include one or more of a tracking reference signal, a non-cell-defining (NCD) synchronization signal block (SSB), a positioning reference signal (PRS), or any combinations thereof.

In some examples, to support receiving the control signaling communication, the PEI resource manager 1235 may be configured as or otherwise support a means for receiving a first PEI in a first set of resources that are configured for the first set of paging subgroups of the first type of UE, and receiving a second PEI in a second set of resources that are configured for the second set of paging subgroups of the second type of UE, where the first PEI and the second PEI are associated with POs separately configured for different UE types, or shared by different UE types. In some examples, the first set of resources are indicated by a first control resource set (CORESET) configuration associated with the first set of paging subgroups, and the second set of resources are indicated by a second CORESET configuration associated with the second set of paging subgroups. In some examples, the first set of resources are associated with a first search space set that is configured for the first set of paging subgroups, and the second set of resources are associated with a second search space set that is configured for the second set of paging subgroups. In some examples, the first PEI is scrambled with a first group radio network temporary identifier (G-RNTI) associated with the first set of paging subgroups, and where a second G-RNTI is used to scramble the second PEI for the second set of paging subgroups. In some examples, the first set of resources are associated with a first DMRS or first waveform configuration that is associated with the first set of paging subgroups, and the second set of resources are associated with a second DMRS or second waveform configuration that is associated with the second set of paging subgroups.

In some examples, to support receiving the control signaling communication, the subgroup ID manager 1240 may be configured as or otherwise support a means for receiving a PEI that includes a multi-bit field that indicates which of the first set of paging subgroups, the second set of paging subgroups, or any combinations thereof, will be paged on the subsequent POs associated with the PEI. In some examples, the first UE monitors the PO for a downlink control channel that provides a resource allocation for a shared channel communication that includes a paging message, and where the downlink control channel indicates that one or more of the first set of paging subgroups or the second set of paging subgroups is to skip decoding of the shared channel communication, based on the shared channel communication not carrying any paging messages for the first set of paging subgroups or the second set of paging subgroups.

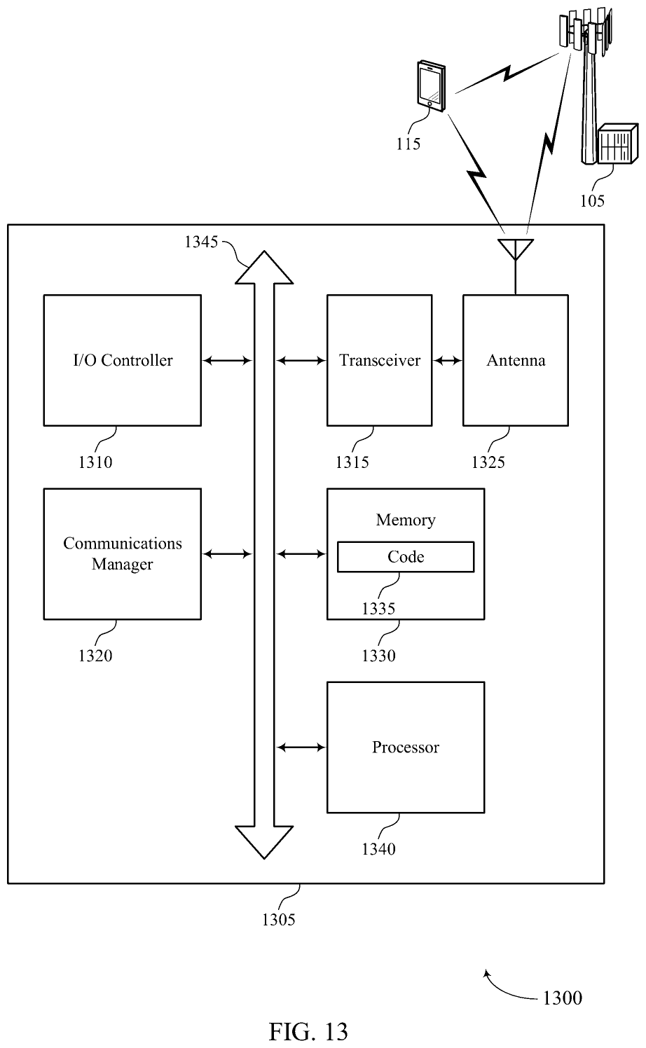

FIG. 13 illustrates a diagram of a system 1300 including a device 1305 that supports paging techniques for wireless devices with mixed capabilities in accordance with one or more aspects of the present disclosure. The device 1305 may be an example of or include the components of a device 1005, a device 1105, or a UE 115 as described herein. The device 1305 may communicate (e.g., wirelessly) with one or more network entities 105, one or more UEs 115, or any combination thereof. The device 1305 may include components for bi-directional voice and data communications including components for transmitting and receiving communications, such as a communications manager 1320, an input/output (I/O) controller 1310, a transceiver 1315, an antenna 1325, a memory 1330, code 1335, and a processor 1340. These components may be in electronic communication or otherwise coupled (e.g., operatively, communicatively, functionally, electronically, electrically) via one or more buses (e.g., a bus 1345).

The I/O controller 1310 may manage input and output signals for the device 1305. The I/O controller 1310 may also manage peripherals not integrated into the device 1305. In some cases, the I/O controller 1310 may represent a physical connection or port to an external peripheral. In some cases, the I/O controller 1310 may utilize an operating system such as iOS®, ANDROID®, MS-DOS®, MS-WINDOWS®, OS/2®, UNIX®, LINUX®, or another known operating system. Additionally or alternatively, the I/O controller 1310 may represent or interact with a modem, a keyboard, a mouse, a touchscreen, or a similar device. In some cases, the I/O controller 1310 may be implemented as part of a processor, such as the processor 1340. In some cases, a user may interact with the device 1305 via the I/O controller 1310 or via hardware components controlled by the I/O controller 1310.

In some cases, the device 1305 may include a single antenna 1325. However, in some other cases, the device 1305 may have more than one antenna 1325, which may be capable of concurrently transmitting or receiving multiple wireless transmissions. The transceiver 1315 may communicate bi-directionally, via the one or more antennas 1325, wired, or wireless links as described herein. For example, the transceiver 1315 may represent a wireless transceiver and may communicate bi-directionally with another wireless transceiver. The transceiver 1315 may also include a modem to modulate the packets, to provide the modulated packets to one or more antennas 1325 for transmission, and to demodulate packets received from the one or more antennas 1325. The transceiver 1315, or the transceiver 1315 and one or more antennas 1325, may be an example of a transmitter 1015, a transmitter 1115, a receiver 1010, a receiver 1110, or any combination thereof or component thereof, as described herein.

The memory 1330 may include random access memory (RAM) and read-only memory (ROM). The memory 1330 may store computer-readable, computer-executable code 1335 including instructions that, when executed by the processor 1340, cause the device 1305 to perform various functions described herein. The code 1335 may be stored in a non-transitory computer-readable medium such as system memory or another type of memory. In some cases, the code 1335 may not be directly executable by the processor 1340 but may cause a computer (e.g., when compiled and executed) to perform functions described herein. In some cases, the memory 1330 may contain, among other things, a basic I/O system (BIOS) which may control basic hardware or software operation such as the interaction with peripheral components or devices.

The processor 1340 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1340 may be configured to operate a memory array using a memory controller. In some other cases, a memory controller may be integrated into the processor 1340. The processor 1340 may be configured to execute computer-readable instructions stored in a memory (e.g., the memory 1330) to cause the device 1305 to perform various functions (e.g., functions or tasks supporting paging techniques for wireless devices with mixed capabilities). For example, the device 1305 or a component of the device 1305 may include a processor 1340 and memory 1330 coupled with or to the processor 1340, the processor 1340 and memory 1330 configured to perform various functions described herein.

The communications manager 1320 may support wireless communications at a first UE in accordance with examples as disclosed herein. For example, the communications manager 1320 may be configured as or otherwise support a means for receiving, in a DRX cycle, a control signaling communication for PEI associated with a subsequent PO configured for multiple different types of UEs, where the PEI includes one or more paging indication fields that are mapped to one or more subgroups of UEs, the one or more subgroups of UEs including a first set of paging subgroups configured for a first type of UE that supports a first receive bandwidth configuration and a second set of paging subgroups configured for a second type of UE that supports a second receive bandwidth configuration that is different than the first receive bandwidth configuration. The communications manager 1320 may be configured as or otherwise support a means for determining whether to monitor the subsequent PO associated with the PEI based on whether a subgroup ID in the PEI is configured for a UE type of the first UE.

By including or configuring the communications manager 1320 in accordance with examples as described herein, the device 1305 may support techniques for indicating whether a UE is to monitor for one or more paging messages, which may reduce power consumption due to shorter UE wakeup times, reduce latency due to improved timing of paging messages, and/or reduced consumption of processing resources due to fewer blind decoding operations, which may provide enhanced system efficiency and enhanced user experience.

In some examples, the communications manager 1320 may be configured to perform various operations (e.g., receiving, monitoring, transmitting) using or otherwise in cooperation with the transceiver 1315, the one or more antennas 1325, or any combination thereof. Although the communications manager 1320 is illustrated as a separate component, in some examples, one or more functions described with reference to the communications manager 1320 may be supported by or performed by the processor 1340, the memory 1330, the code 1335, or any combination thereof. For example, the code 1335 may include instructions executable by the processor 1340 to cause the device 1305 to perform various aspects of paging techniques for wireless devices with mixed capabilities as described herein, or the processor 1340 and the memory 1330 may be otherwise configured to perform or support such operations.

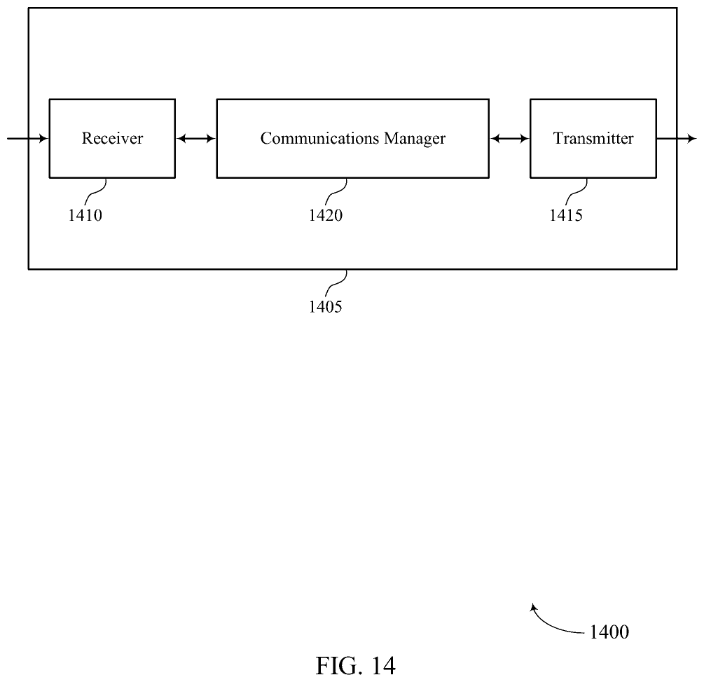

FIG. 14 illustrates a block diagram 1400 of a device 1405 that supports paging techniques for wireless devices with mixed capabilities in accordance with one or more aspects of the present disclosure. The device 1405 may be an example of aspects of a network entity 105 as described herein. The device 1405 may include a receiver 1410, a transmitter 1415, and a communications manager 1420. The device 1405 may also include a processor. Each of these components may be in communication with one another (e.g., via one or more buses).

The receiver 1410 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1405. In some examples, the receiver 1410 may support obtaining information by receiving signals via one or more antennas. Additionally, or alternatively, the receiver 1410 may support obtaining information by receiving signals via one or more wired (e.g., electrical, fiber optic) interfaces, wireless interfaces, or any combination thereof.

The transmitter 1415 may provide a means for outputting (e.g., transmitting, providing, conveying, sending) information generated by other components of the device 1405. For example, the transmitter 1415 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1415 may support outputting information by transmitting signals via one or more antennas. Additionally, or alternatively, the transmitter 1415 may support outputting information by transmitting signals via one or more wired (e.g., electrical, fiber optic) interfaces, wireless interfaces, or any combination thereof. In some examples, the transmitter 1415 and the receiver 1410 may be co-located in a transceiver, which may include or be coupled with a modem.

The communications manager 1420, the receiver 1410, the transmitter 1415, or various combinations thereof or various components thereof may be examples of means for performing various aspects of paging techniques for wireless devices with mixed capabilities as described herein. For example, the communications manager 1420, the receiver 1410, the transmitter 1415, or various combinations or components thereof may support a method for performing one or more of the functions described herein.

In some examples, the communications manager 1420, the receiver 1410, the transmitter 1415, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1420, the receiver 1410, the transmitter 1415, or various combinations or components thereof may be implemented in code (e.g., as communications management software or firmware) executed by a processor. If implemented in code executed by a processor, the functions of the communications manager 1420, the receiver 1410, the transmitter 1415, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1420 may be configured to perform various operations (e.g., receiving, obtaining, monitoring, outputting, transmitting) using or otherwise in cooperation with the receiver 1410, the transmitter 1415, or both. For example, the communications manager 1420 may receive information from the receiver 1410, send information to the transmitter 1415, or be integrated in combination with the receiver 1410, the transmitter 1415, or both to obtain information, output information, or perform various other operations as described herein.

The communications manager 1420 may support wireless communications at a network entity in accordance with examples as disclosed herein. For example, the communications manager 1420 may be configured as or otherwise support a means for transmitting to at least a first UE, in a DRX cycle, a control signaling communication for PEI associated with a subsequent PO configured for multiple different types of UEs, where the PEI includes one or more paging indication fields that are mapped to one or more subgroups of UEs, the one or more subgroups of UEs including a first set of paging subgroups configured for a first type of UE that supports a first receive bandwidth configuration and a second set of paging subgroups configured for a second type of UE that supports a second receive bandwidth configuration that is different than the first receive bandwidth configuration. The communications manager 1420 may be configured as or otherwise support a means for transmitting a paging message to the first UE in a first paging resource associated with the first type of UE based on the first UE being the first type of UE and a subgroup ID in the PEI being configured for the first type of UE type of UE.

By including or configuring the communications manager 1420 in accordance with examples as described herein, the device 1405 (e.g., a processor controlling or otherwise coupled with the receiver 1410, the transmitter 1415, the communications manager 1420, or a combination thereof) may support techniques for indicating whether a UE is to monitor for one or more paging messages, which may reduce power consumption due to shorter UE wakeup times, reduce latency due to improved timing of paging messages, and/or reduced consumption of processing resources due to fewer blind decoding operations, which may provide enhanced system efficiency and enhanced user experience.

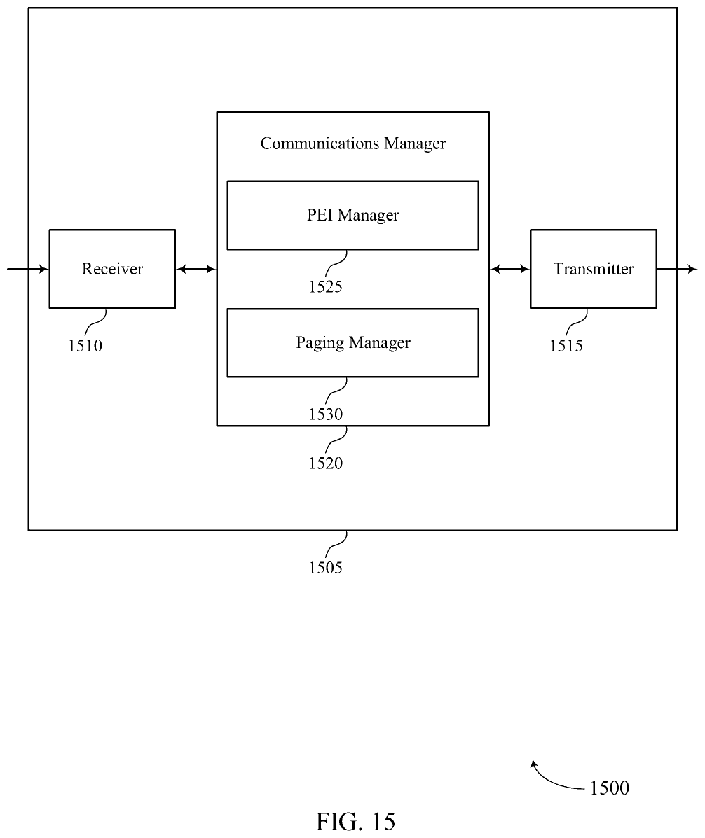

FIG. 15 illustrates a block diagram 1500 of a device 1505 that supports paging techniques for wireless devices with mixed capabilities in accordance with one or more aspects of the present disclosure. The device 1505 may be an example of aspects of a device 1405 or a network entity 105 as described herein. The device 1505 may include a receiver 1510, a transmitter 1515, and a communications manager 1520. The device 1505 may also include a processor. Each of these components may be in communication with one another (e.g., via one or more buses).

The receiver 1510 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1505. In some examples, the receiver 1510 may support obtaining information by receiving signals via one or more antennas. Additionally, or alternatively, the receiver 1510 may support obtaining information by receiving signals via one or more wired (e.g., electrical, fiber optic) interfaces, wireless interfaces, or any combination thereof.

The transmitter 1515 may provide a means for outputting (e.g., transmitting, providing, conveying, sending) information generated by other components of the device 1505. For example, the transmitter 1515 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1515 may support outputting information by transmitting signals via one or more antennas. Additionally, or alternatively, the transmitter 1515 may support outputting information by transmitting signals via one or more wired (e.g., electrical, fiber optic) interfaces, wireless interfaces, or any combination thereof. In some examples, the transmitter 1515 and the receiver 1510 may be co-located in a transceiver, which may include or be coupled with a modem.

The device 1505, or various components thereof, may be an example of means for performing various aspects of paging techniques for wireless devices with mixed capabilities as described herein. For example, the communications manager 1520 may include a PEI manager 1525 a paging manager 1530, or any combination thereof. The communications manager 1520 may be an example of aspects of a communications manager 1420 as described herein. In some examples, the communications manager 1520, or various components thereof, may be configured to perform various operations (e.g., receiving, obtaining, monitoring, outputting, transmitting) using or otherwise in cooperation with the receiver 1510, the transmitter 1515, or both. For example, the communications manager 1520 may receive information from the receiver 1510, send information to the transmitter 1515, or be integrated in combination with the receiver 1510, the transmitter 1515, or both to obtain information, output information, or perform various other operations as described herein.

The communications manager 1520 may support wireless communications at a network entity in accordance with examples as disclosed herein. The PEI manager 1525 may be configured as or otherwise support a means for transmitting to at least a first UE, in a DRX cycle, a control signaling communication for PEI associated with a subsequent PO configured for multiple different types of UEs, where the PEI includes one or more paging indication fields that are mapped to one or more subgroups of UEs, the one or more subgroups of UEs including a first set of paging subgroups configured for a first type of UE that supports a first receive bandwidth configuration and a second set of paging subgroups configured for a second type of UE that supports a second receive bandwidth configuration that is different than the first receive bandwidth configuration. The paging manager 1530 may be configured as or otherwise support a means for transmitting a paging message to the first UE in a first paging resource associated with the first type of UE based on the first UE being the first type of UE and a subgroup ID in the PEI being configured for the first type of UE type of UE.

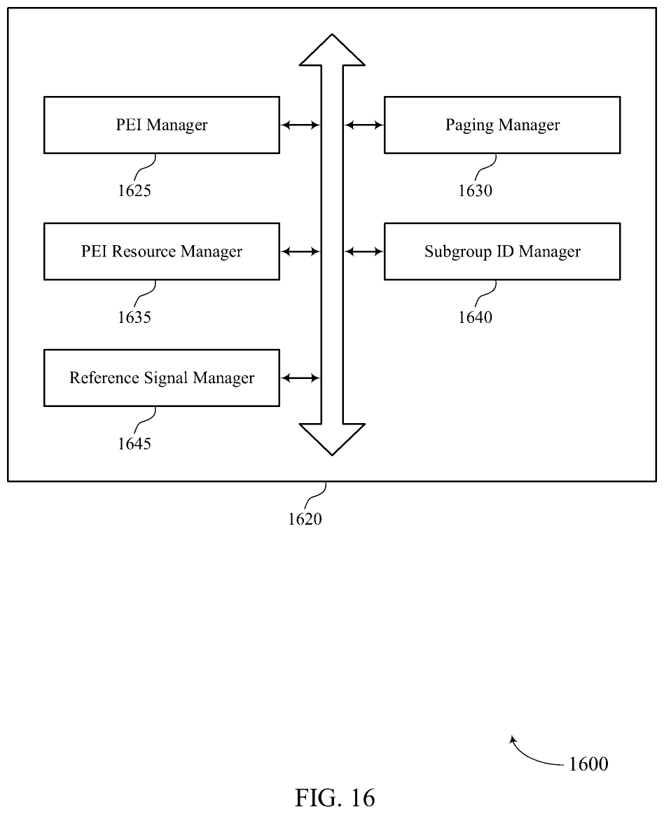

FIG. 16 illustrates a block diagram 1600 of a communications manager 1620 that supports paging techniques for wireless devices with mixed capabilities in accordance with one or more aspects of the present disclosure. The communications manager 1620 may be an example of aspects of a communications manager 1420, a communications manager 1520, or both, as described herein. The communications manager 1620, or various components thereof, may be an example of means for performing various aspects of paging techniques for wireless devices with mixed capabilities as described herein. For example, the communications manager 1620 may include a PEI manager 1625, a paging manager 1630, a PEI resource manager 1635, a subgroup ID manager 1640, a reference signal manager 1645, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1620 may support wireless communications at a network entity in accordance with examples as disclosed herein. The PEI manager 1625 may be configured as or otherwise support a means for transmitting to at least a first UE, in a DRX cycle, a control signaling communication for PEI associated with a subsequent PO configured for multiple different types of UEs, where the PEI includes one or more paging indication fields that are mapped to one or more subgroups of UEs, the one or more subgroups of UEs including a first set of paging subgroups configured for a first type of UE that supports a first receive bandwidth configuration and a second set of paging subgroups configured for a second type of UE that supports a second receive bandwidth configuration that is different than the first receive bandwidth configuration. The paging manager 1630 may be configured as or otherwise support a means for transmitting a paging message to the first UE in a first paging resource associated with the first type of UE based on the first UE being the first type of UE and a subgroup ID in the PEI being configured for the first type of UE type of UE.

In some examples, the PEI manager 1625 may be configured as or otherwise support a means for configuring one or more UEs to skip monitoring one or more subsequent POs associated with the PEI based on a paging indication field indicating the subgroup ID configured for the first UE type or the second UE type associated with each of the one or more UEs will not be paged on the subsequent POs associated with the PEI. In some examples, to support transmitting the control signaling communication, the PEI manager 1625 may be configured as or otherwise support a means for transmitting, in the DRX cycle, the PEI that includes a set of multiple paging indication fields for multiple UE types which are allowed to monitor paging messages, short messages, system information, other control signaling of a serving network entity, or any combinations thereof.

In some examples, each paging indication field of the set of multiple paging indication fields is associated with an identification of a set of different paging subgroup IDs, and indicates if UEs sharing a same subgroup ID will be paged on the subsequent POs associated with the PEI. In some examples, the set of multiple paging indication fields include one or more of a first paging indication field, a second paging indication field, or a third paging indication field, where the first paging indication field provides a first set of subgroup IDs that are configured by a core network entity, the second paging indication field provides a second set of subgroup IDs that are associated with a UE ID or UE class ID, and the third paging indication field provides a third set of subgroup IDs that are configured at a serving cell belonging to a radio area network (RAN) notification area (RNA) of the UE. In some examples, first control signaling further indicates one or more downlink reference signals associated with the one or more subgroups of UEs are activated for UEs in IDLE or INACTIVE states. In some examples, the one or more downlink reference signals include one or more of a tracking reference signal, a non-cell-defining (NCD) synchronization signal block (SSB), a positioning reference signal (PRS), or any combinations thereof.

In some examples, to support transmitting the control signaling communication, the PEI resource manager 1635 may be configured as or otherwise support a means for transmitting a first PEI in a first set of resources that are configured for the first set of paging subgroups of the first type of UE. In some examples, to support transmitting the control signaling communication, the PEI resource manager 1635 may be configured as or otherwise support a means for transmitting a second PEI in a second set of resources that are configured for the second set of paging subgroups of the second type of UE, where the first PEI and the second PEI are associated with POs separately configured for different UE types, or shared by different UE types.

In some examples, the first set of resources are indicated by a first control resource set (CORESET) configuration associated with the first set of paging subgroups, and the second set of resources are indicated by a second CORESET configuration associated with the second set of paging subgroups. In some examples, the first set of resources are associated with a first search space set that is configured for the first set of paging subgroups, and the second set of resources are associated with a second search space set that is configured for the second set of paging subgroups. In some examples, the first PEI is scrambled with a first group radio network temporary identifier (G-RNTI) associated with the first set of paging subgroups, and where a second G-RNTI is used to scramble the second PEI for the second set of paging subgroups. In some examples, the first set of resources are associated with a first DMRS or first waveform configuration that is associated with the first set of paging subgroups, and the second set of resources are associated with a second DMRS or second waveform configuration that is associated with the second set of paging subgroups.

In some examples, to support transmitting the control signaling communication, the subgroup ID manager 1640 may be configured as or otherwise support a means for transmitting a PEI that includes a multi-bit field that indicates which of the first set of paging subgroups, the second set of paging subgroups, or any combinations thereof, will be paged on the subsequent POs associated with the PEI. In some examples, the first UE monitors the PO for a downlink control channel that provides a resource allocation for a shared channel communication that includes a paging message, and where the downlink control channel indicates that one or more of the first set of paging subgroups or the second set of paging subgroups is to skip decoding of the shared channel communication, based on the shared channel communication not carrying any paging messages for the first set of paging subgroups or the second set of paging subgroups.

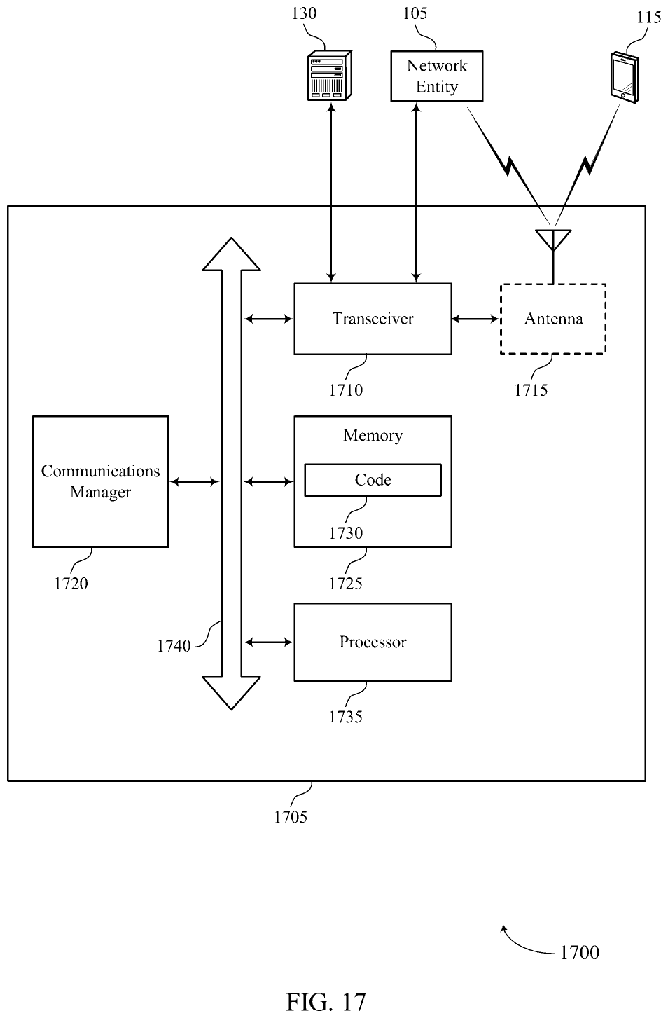

FIG. 17 illustrates a diagram of a system 1700 including a device 1705 that supports paging techniques for wireless devices with mixed capabilities in accordance with one or more aspects of the present disclosure. The device 1705 may be an example of or include the components of a device 1405, a device 1505, or a network entity 105 as described herein. The device 1705 may communicate with one or more network entities 105, one or more UEs 115, or any combination thereof, which may include communications over one or more wired interfaces, over one or more wireless interfaces, or any combination thereof. The device 1705 may include components that support outputting and obtaining communications, such as a communications manager 1720, a transceiver 1710, an antenna 1715, a memory 1725, code 1730, and a processor 1735. These components may be in electronic communication or otherwise coupled (e.g., operatively, communicatively, functionally, electronically, electrically) via one or more buses (e.g., a bus 1740).

The transceiver 1710 may support bi-directional communications via wired links, wireless links, or both as described herein. In some examples, the transceiver 1710 may include a wired transceiver and may communicate bi-directionally with another wired transceiver. Additionally, or alternatively, in some examples, the transceiver 1710 may include a wireless transceiver and may communicate bi-directionally with another wireless transceiver. In some examples, the device 1705 may include one or more antennas 1715, which may be capable of transmitting or receiving wireless transmissions (e.g., concurrently). The transceiver 1710 may also include a modem to modulate signals, to provide the modulated signals for transmission (e.g., by one or more antennas 1715, by a wired transmitter), to receive modulated signals (e.g., from one or more antennas 1715, from a wired receiver), and to demodulate signals. In some implementations, the transceiver 1710 may include one or more interfaces, such as one or more interfaces coupled with the one or more antennas 1715 that are configured to support various receiving or obtaining operations, or one or more interfaces coupled with the one or more antennas 1715 that are configured to support various transmitting or outputting operations, or a combination thereof. In some implementations, the transceiver 1710 may include or be configured for coupling with one or more processors or memory components that are operable to perform or support operations based on received or obtained information or signals, or to generate information or other signals for transmission or other outputting, or any combination thereof. In some implementations, the transceiver 1710, or the transceiver 1710 and the one or more antennas 1715, or the transceiver 1710 and the one or more antennas 1715 and one or more processors or memory components (for example, the processor 1735, or the memory 1725, or both), may be included in a chip or chip assembly that is installed in the device 1705. In some examples, the transceiver may be operable to support communications via one or more communications links (e.g., a communication link 125, a backhaul communication link 120, a midhaul communication link 162, a fronthaul communication link 168).

The memory 1725 may include RAM and ROM. The memory 1725 may store computer-readable, computer-executable code 1730 including instructions that, when executed by the processor 1735, cause the device 1705 to perform various functions described herein. The code 1730 may be stored in a non-transitory computer-readable medium such as system memory or another type of memory. In some cases, the code 1730 may not be directly executable by the processor 1735 but may cause a computer (e.g., when compiled and executed) to perform functions described herein. In some cases, the memory 1725 may contain, among other things, a BIOS which may control basic hardware or software operation such as the interaction with peripheral components or devices.

The processor 1735 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1735 may be configured to operate a memory array using a memory controller. In some other cases, a memory controller may be integrated into the processor 1735. The processor 1735 may be configured to execute computer-readable instructions stored in a memory (e.g., the memory 1725) to cause the device 1705 to perform various functions (e.g., functions or tasks supporting paging techniques for wireless devices with mixed capabilities). For example, the device 1705 or a component of the device 1705 may include a processor 1735 and memory 1725 coupled with the processor 1735, the processor 1735 and memory 1725 configured to perform various functions described herein. The processor 1735 may be an example of a cloud-computing platform (e.g., one or more physical nodes and supporting software such as operating systems, virtual machines, or container instances) that may host the functions (e.g., by executing code 1730) to perform the functions of the device 1705. The processor 1735 may be any one or more suitable processors capable of executing scripts or instructions of one or more software programs stored in the device 1705 (such as within the memory 1725). In some implementations, the processor 1735 may be a component of a processing system. A processing system may generally refer to a system or series of machines or components that receives inputs and processes the inputs to produce a set of outputs (which may be passed to other systems or components of, for example, the device 1705). For example, a processing system of the device 1705 may refer to a system including the various other components or subcomponents of the device 1705, such as the processor 1735, or the transceiver 1710, or the communications manager 1720, or other components or combinations of components of the device 1705. The processing system of the device 1705 may interface with other components of the device 1705, and may process information received from other components (such as inputs or signals) or output information to other components. For example, a chip or modem of the device 1705 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1705 may transmit information output from the chip or modem. Additionally, or alternatively, in some implementations, the one or more interfaces may refer to an interface between the processing system of the chip or modem and a receiver, such that the device 1705 may obtain information or signal inputs, and the information may be passed to the processing system. A person having ordinary skill in the art will readily recognize that a first interface also may obtain information or signal inputs, and a second interface also may output information or signal outputs.

In some examples, a bus 1740 may support communications of (e.g., within) a protocol layer of a protocol stack. In some examples, a bus 1740 may support communications associated with a logical channel of a protocol stack (e.g., between protocol layers of a protocol stack), which may include communications performed within a component of the device 1705, or between different components of the device 1705 that may be co-located or located in different locations (e.g., where the device 1705 may refer to a system in which one or more of the communications manager 1720, the transceiver 1710, the memory 1725, the code 1730, and the processor 1735 may be located in one of the different components or divided between different components).

In some examples, the communications manager 1720 may manage aspects of communications with a core network 130 (e.g., via one or more wired or wireless backhaul links). For example, the communications manager 1720 may manage the transfer of data communications for client devices, such as one or more UEs 115. In some examples, the communications manager 1720 may manage communications with other network entities 105, and may include a controller or scheduler for controlling communications with UEs 115 in cooperation with other network entities 105. In some examples, the communications manager 1720 may support an X2 interface within an LTE/LTE-A wireless communications network technology to provide communication between network entities 105.

The communications manager 1720 may support wireless communications at a network entity in accordance with examples as disclosed herein. For example, the communications manager 1720 may be configured as or otherwise support a means for transmitting to at least a first UE, in a DRX cycle, a control signaling communication for PEI associated with a subsequent PO configured for multiple different types of UEs, where the PEI includes one or more paging indication fields that are mapped to one or more subgroups of UEs, the one or more subgroups of UEs including a first set of paging subgroups configured for a first type of UE that supports a first receive bandwidth configuration and a second set of paging subgroups configured for a second type of UE that supports a second receive bandwidth configuration that is different than the first receive bandwidth configuration. The communications manager 1720 may be configured as or otherwise support a means for transmitting a paging message to the first UE in a first paging resource associated with the first type of UE based on the first UE being the first type of UE and a subgroup ID in the PEI being configured for the first type of UE type of UE.

By including or configuring the communications manager 1720 in accordance with examples as described herein, the device 1705 may support techniques for indicating whether a UE is to monitor for one or more paging messages, which may reduce power consumption due to shorter UE wakeup times, reduce latency due to improved timing of paging messages, and/or reduced consumption of processing resources due to fewer blind decoding operations, which may provide enhanced system efficiency and enhanced user experience.

In some examples, the communications manager 1720 may be configured to perform various operations (e.g., receiving, obtaining, monitoring, outputting, transmitting) using or otherwise in cooperation with the transceiver 1710, the one or more antennas 1715 (e.g., where applicable), or any combination thereof. Although the communications manager 1720 is illustrated as a separate component, in some examples, one or more functions described with reference to the communications manager 1720 may be supported by or performed by the transceiver 1710, the processor 1735, the memory 1725, the code 1730, or any combination thereof. For example, the code 1730 may include instructions executable by the processor 1735 to cause the device 1705 to perform various aspects of paging techniques for wireless devices with mixed capabilities as described herein, or the processor 1735 and the memory 1725 may be otherwise configured to perform or support such operations.

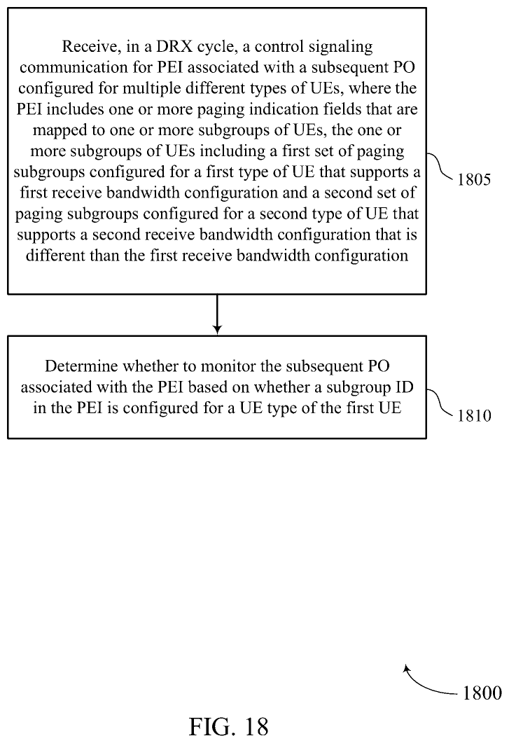

FIG. 18 illustrates a flowchart illustrating a method 1800 that supports paging techniques for wireless devices with mixed capabilities in accordance with one or more aspects of the present disclosure. The operations of the method 1800 may be implemented by a UE or its components as described herein. For example, the operations of the method 1800 may be performed by a UE 115 as described with reference to FIGS. 1 through 13. In some examples, a UE may execute a set of instructions to control the functional elements of the UE to perform the described functions. Additionally, or alternatively, the UE may perform aspects of the described functions using special-purpose hardware.

At 1805, the method may include receiving, in a DRX cycle, a control signaling communication for PEI associated with a subsequent PO configured for multiple different types of UEs, where the PEI includes one or more paging indication fields that are mapped to one or more subgroups of UEs, the one or more subgroups of UEs including a first set of paging subgroups configured for a first type of UE that supports a first receive bandwidth configuration and a second set of paging subgroups configured for a second type of UE that supports a second receive bandwidth configuration that is different than the first receive bandwidth configuration. The operations of 1805 may be performed in accordance with examples as disclosed herein. In some examples, aspects of the operations of 1805 may be performed by a PEI manager 1225 as described with reference to FIG. 12.

At 1810, the method may include determining whether to monitor the subsequent PO associated with the PEI based on whether a subgroup ID in the PEI is configured for a UE type of the first UE. The operations of 1810 may be performed in accordance with examples as disclosed herein. In some examples, aspects of the operations of 1810 may be performed by a paging manager 1230 as described with reference to FIG. 12.

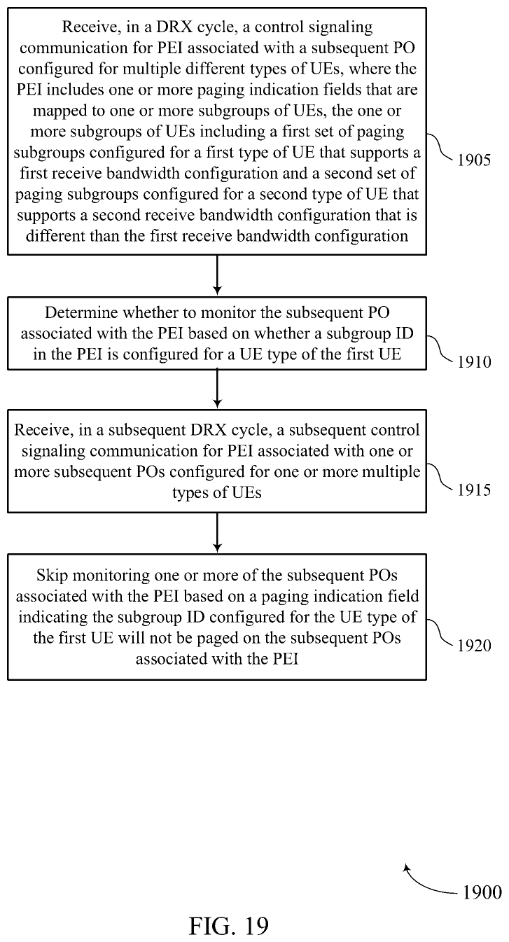

FIG. 19 illustrates a flowchart illustrating a method 1900 that supports paging techniques for wireless devices with mixed capabilities in accordance with one or more aspects of the present disclosure. The operations of the method 1900 may be implemented by a UE or its components as described herein. For example, the operations of the method 1900 may be performed by a UE 115 as described with reference to FIGS. 1 through 13. In some examples, a UE may execute a set of instructions to control the functional elements of the UE to perform the described functions. Additionally, or alternatively, the UE may perform aspects of the described functions using special-purpose hardware.

At 1905, the method may include receiving, in a DRX cycle, a control signaling communication for PEI associated with a subsequent PO configured for multiple different types of UEs, where the PEI includes one or more paging indication fields that are mapped to one or more subgroups of UEs, the one or more subgroups of UEs including a first set of paging subgroups configured for a first type of UE that supports a first receive bandwidth configuration and a second set of paging subgroups configured for a second type of UE that supports a second receive bandwidth configuration that is different than the first receive bandwidth configuration. The operations of 1905 may be performed in accordance with examples as disclosed herein. In some examples, aspects of the operations of 1905 may be performed by a PEI manager 1225 as described with reference to FIG. 12.

At 1910, the method may include determining whether to monitor the subsequent PO associated with the PEI based on whether a subgroup ID in the PEI is configured for a UE type of the first UE. The operations of 1910 may be performed in accordance with examples as disclosed herein. In some examples, aspects of the operations of 1910 may be performed by a paging manager 1230 as described with reference to FIG. 12.

At 1915, the method may include receiving, in a subsequent DRX cycle, a subsequent control signaling communication for PEI associated with one or more subsequent POs configured for one or more multiple types of UEs. The operations of 1915 may be performed in accordance with examples as disclosed herein. In some examples, aspects of the operations of 1915 may be performed by a PEI manager 1225 as described with reference to FIG. 12.

At 1920, the method may include skipping monitoring one or more of the subsequent POs associated with the PEI based on a paging indication field indicating the subgroup ID configured for the UE type of the first UE will not be paged on the subsequent POs associated with the PEI. The operations of 1920 may be performed in accordance with examples as disclosed herein. In some examples, aspects of the operations of 1920 may be performed by a paging manager 1230 as described with reference to FIG. 12.

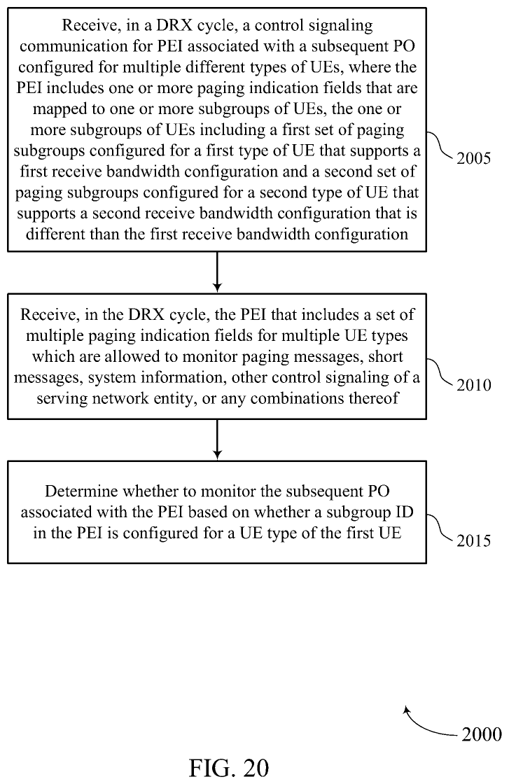

FIG. 20 illustrates a flowchart illustrating a method 2000 that supports paging techniques for wireless devices with mixed capabilities in accordance with one or more aspects of the present disclosure. The operations of the method 2000 may be implemented by a UE or its components as described herein. For example, the operations of the method 2000 may be performed by a UE 115 as described with reference to FIGS. 1 through 13. In some examples, a UE may execute a set of instructions to control the functional elements of the UE to perform the described functions. Additionally, or alternatively, the UE may perform aspects of the described functions using special-purpose hardware.

At 2005, the method may include receiving, in a DRX cycle, a control signaling communication for PEI associated with a subsequent PO configured for multiple different types of UEs, where the PEI includes one or more paging indication fields that are mapped to one or more subgroups of UEs, the one or more subgroups of UEs including a first set of paging subgroups configured for a first type of UE that supports a first receive bandwidth configuration and a second set of paging subgroups configured for a second type of UE that supports a second receive bandwidth configuration that is different than the first receive bandwidth configuration. The operations of 2005 may be performed in accordance with examples as disclosed herein. In some examples, aspects of the operations of 2005 may be performed by a PEI manager 1225 as described with reference to FIG. 12.

At 2010, the method may include receiving, in the DRX cycle, the PEI that includes a set of multiple paging indication fields for multiple UE types which are allowed to monitor paging messages, short messages, system information, other control signaling of a serving network entity, or any combinations thereof. The operations of 2010 may be performed in accordance with examples as disclosed herein. In some examples, aspects of the operations of 2010 may be performed by a PEI manager 1225 as described with reference to FIG. 12.

At 2015, the method may include determining whether to monitor the subsequent PO associated with the PEI based on whether a subgroup ID in the PEI is configured for a UE type of the first UE. The operations of 2015 may be performed in accordance with examples as disclosed herein. In some examples, aspects of the operations of 2015 may be performed by a paging manager 1230 as described with reference to FIG. 12.

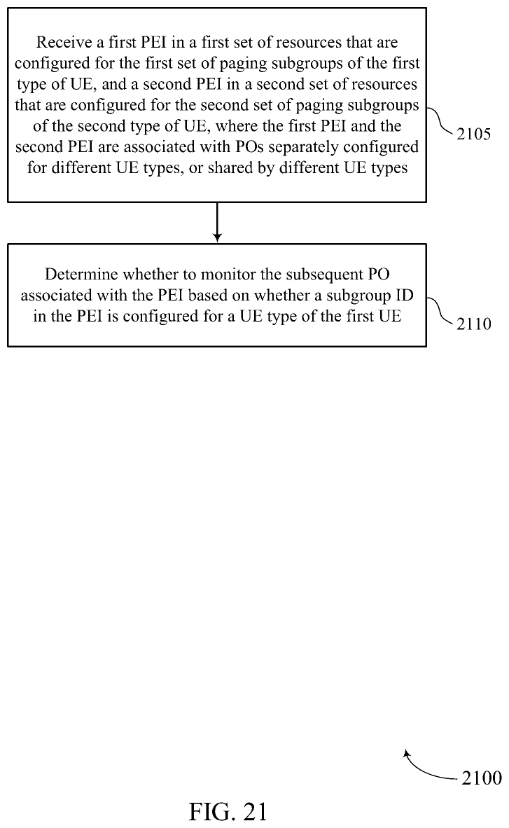

FIG. 21 illustrates a flowchart illustrating a method 2100 that supports paging techniques for wireless devices with mixed capabilities in accordance with one or more aspects of the present disclosure. The operations of the method 2100 may be implemented by a UE or its components as described herein. For example, the operations of the method 2100 may be performed by a UE 115 as described with reference to FIGS. 1 through 13. In some examples, a UE may execute a set of instructions to control the functional elements of the UE to perform the described functions. Additionally, or alternatively, the UE may perform aspects of the described functions using special-purpose hardware.

At 2105, the method may include receiving a first PEI in a first set of resources that are configured for the first set of paging subgroups of the first type of UE, and receiving a second PEI in a second set of resources that are configured for the second set of paging subgroups of the second type of UE, where the first PEI and the second PEI are associated with POs separately configured for different UE types, or shared by different UE types. The operations of 2105 may be performed in accordance with examples as disclosed herein. In some examples, aspects of the operations of 2105 may be performed by a PEI resource manager 1235 as described with reference to FIG. 12.

At 2110, the method may include determining whether to monitor the subsequent PO associated with the PEI based on whether a subgroup ID in the PEI is configured for a UE type of the first UE. The operations of 2110 may be performed in accordance with examples as disclosed herein. In some examples, aspects of the operations of 2110 may be performed by a paging manager 1230 as described with reference to FIG. 12.

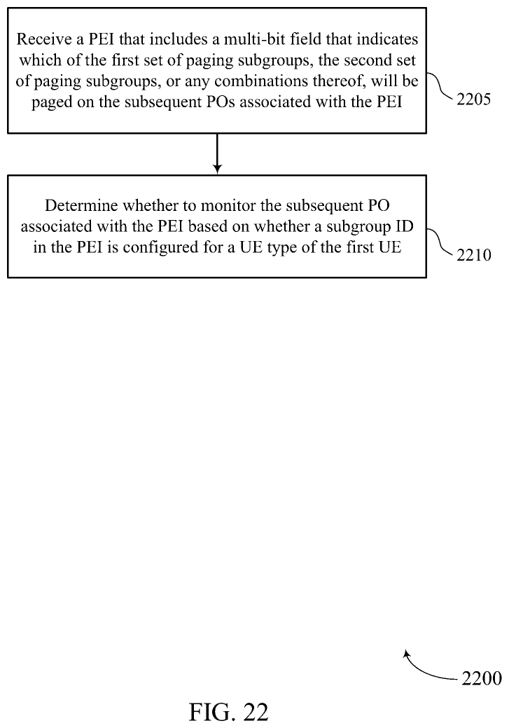

FIG. 22 illustrates a flowchart illustrating a method 2200 that supports paging techniques for wireless devices with mixed capabilities in accordance with one or more aspects of the present disclosure. The operations of the method 2200 may be implemented by a UE or its components as described herein. For example, the operations of the method 2200 may be performed by a UE 115 as described with reference to FIGS. 1 through 13. In some examples, a UE may execute a set of instructions to control the functional elements of the UE to perform the described functions. Additionally, or alternatively, the UE may perform aspects of the described functions using special-purpose hardware.

At 2205, the method may include receiving a PEI that includes a multi-bit field that indicates which of the first set of paging subgroups, the second set of paging subgroups, or any combinations thereof, will be paged on the subsequent POs associated with the PEI. The operations of 2205 may be performed in accordance with examples as disclosed herein. In some examples, aspects of the operations of 2205 may be performed by a subgroup ID manager 1240 as described with reference to FIG. 12.

At 2210, the method may include determining whether to monitor the subsequent PO associated with the PEI based on whether a subgroup ID in the PEI is configured for a UE type of the first UE. The operations of 2210 may be performed in accordance with examples as disclosed herein. In some examples, aspects of the operations of 2210 may be performed by a paging manager 1230 as described with reference to FIG. 12.

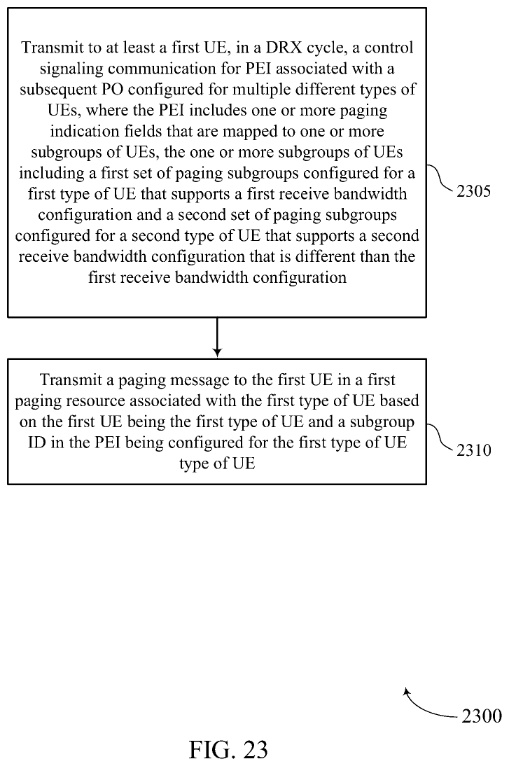

FIG. 23 illustrates a flowchart illustrating a method 2300 that supports paging techniques for wireless devices with mixed capabilities in accordance with one or more aspects of the present disclosure. The operations of the method 2300 may be implemented by a network entity or its components as described herein. For example, the operations of the method 2300 may be performed by a network entity as described with reference to FIGS. 1 through 9 and 14 through 17. In some examples, a network entity may execute a set of instructions to control the functional elements of the network entity to perform the described functions. Additionally, or alternatively, the network entity may perform aspects of the described functions using special-purpose hardware.

At 2305, the method may include transmitting to at least a first UE, in a DRX cycle, a control signaling communication for PEI associated with a subsequent PO configured for multiple different types of UEs, where the PEI includes one or more paging indication fields that are mapped to one or more subgroups of UEs, the one or more subgroups of UEs including a first set of paging subgroups configured for a first type of UE that supports a first receive bandwidth configuration and a second set of paging subgroups configured for a second type of UE that supports a second receive bandwidth configuration that is different than the first receive bandwidth configuration. The operations of 2305 may be performed in accordance with examples as disclosed herein. In some examples, aspects of the operations of 2305 may be performed by a PEI manager 1625 as described with reference to FIG. 16.

At 2310, the method may include transmitting a paging message to the first UE in a first paging resource associated with the first type of UE based on the first UE being the first type of UE and a subgroup ID in the PEI being configured for the first type of UE type of UE. The operations of 2310 may be performed in accordance with examples as disclosed herein. In some examples, aspects of the operations of 2310 may be performed by a paging manager 1630 as described with reference to FIG. 16.

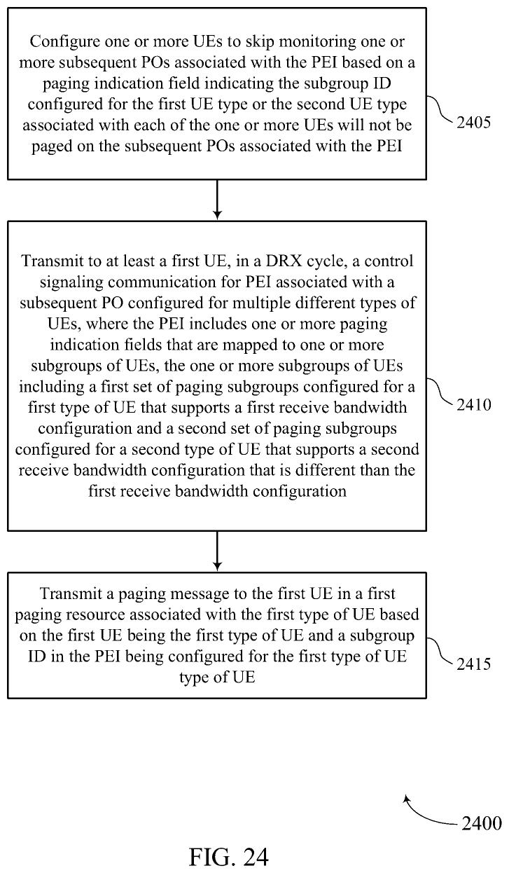

FIG. 24 illustrates a flowchart illustrating a method 2400 that supports paging techniques for wireless devices with mixed capabilities in accordance with one or more aspects of the present disclosure. The operations of the method 2400 may be implemented by a network entity or its components as described herein. For example, the operations of the method 2400 may be performed by a network entity as described with reference to FIGS. 1 through 9 and 14 through 17. In some examples, a network entity may execute a set of instructions to control the functional elements of the network entity to perform the described functions. Additionally, or alternatively, the network entity may perform aspects of the described functions using special-purpose hardware.

At 2405, the method may include configuring one or more UEs to skip monitoring one or more subsequent POs associated with the PEI based on a paging indication field indicating the subgroup ID configured for the first UE type or the second UE type associated with each of the one or more UEs will not be paged on the subsequent POs associated with the PEI. The operations of 2405 may be performed in accordance with examples as disclosed herein. In some examples, aspects of the operations of 2405 may be performed by a PEI manager 1625 as described with reference to FIG. 16.

At 2410, the method may include transmitting to at least a first UE, in a DRX cycle, a control signaling communication for PEI associated with a subsequent PO configured for multiple different types of UEs, where the PEI includes one or more paging indication fields that are mapped to one or more subgroups of UEs, the one or more subgroups of UEs including a first set of paging subgroups configured for a first type of UE that supports a first receive bandwidth configuration and a second set of paging subgroups configured for a second type of UE that supports a second receive bandwidth configuration that is different than the first receive bandwidth configuration. The operations of 2410 may be performed in accordance with examples as disclosed herein. In some examples, aspects of the operations of 2410 may be performed by a PEI manager 1625 as described with reference to FIG. 16.

At 2415, the method may include transmitting a paging message to the first UE in a first paging resource associated with the first type of UE based on the first UE being the first type of UE and a subgroup ID in the PEI being configured for the first type of UE type of UE. The operations of 2415 may be performed in accordance with examples as disclosed herein. In some examples, aspects of the operations of 2415 may be performed by a paging manager 1630 as described with reference to FIG. 16.

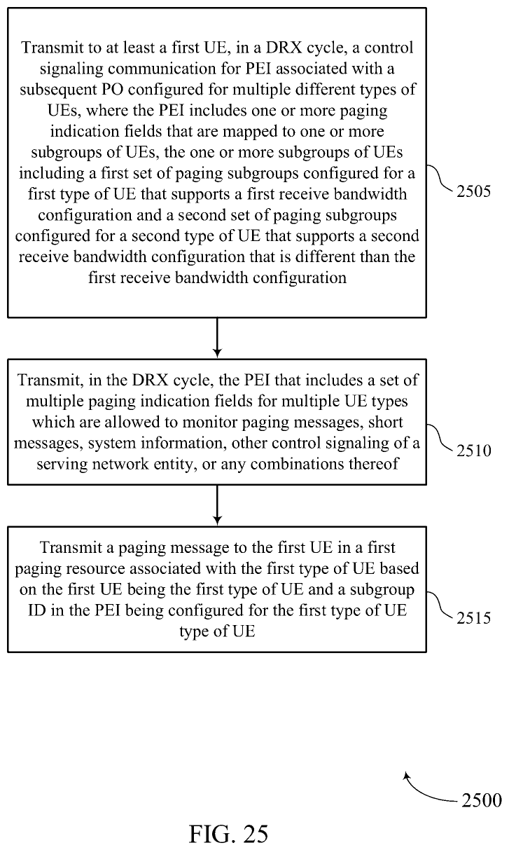

FIG. 25 illustrates a flowchart illustrating a method 2500 that supports paging techniques for wireless devices with mixed capabilities in accordance with one or more aspects of the present disclosure. The operations of the method 2500 may be implemented by a network entity or its components as described herein. For example, the operations of the method 2500 may be performed by a network entity as described with reference to FIGS. 1 through 9 and 14 through 17. In some examples, a network entity may execute a set of instructions to control the functional elements of the network entity to perform the described functions. Additionally, or alternatively, the network entity may perform aspects of the described functions using special-purpose hardware.

At 2505, the method may include transmitting to at least a first UE, in a DRX cycle, a control signaling communication for PEI associated with a subsequent PO configured for multiple different types of UEs, where the PEI includes one or more paging indication fields that are mapped to one or more subgroups of UEs, the one or more subgroups of UEs including a first set of paging subgroups configured for a first type of UE that supports a first receive bandwidth configuration and a second set of paging subgroups configured for a second type of UE that supports a second receive bandwidth configuration that is different than the first receive bandwidth configuration. The operations of 2505 may be performed in accordance with examples as disclosed herein. In some examples, aspects of the operations of 2505 may be performed by a PEI manager 1625 as described with reference to FIG. 16.

At 2510, the method may include transmitting, in the DRX cycle, the PEI that includes a set of multiple paging indication fields for multiple UE types which are allowed to monitor paging messages, short messages, system information, other control signaling of a serving network entity, or any combinations thereof. The operations of 2510 may be performed in accordance with examples as disclosed herein. In some examples, aspects of the operations of 2510 may be performed by a PEI manager 1625 as described with reference to FIG. 16.

At 2515, the method may include transmitting a paging message to the first UE in a first paging resource associated with the first type of UE based on the first UE being the first type of UE and a subgroup ID in the PEI being configured for the first type of UE type of UE. The operations of 2515 may be performed in accordance with examples as disclosed herein. In some examples, aspects of the operations of 2515 may be performed by a paging manager 1630 as described with reference to FIG. 16.

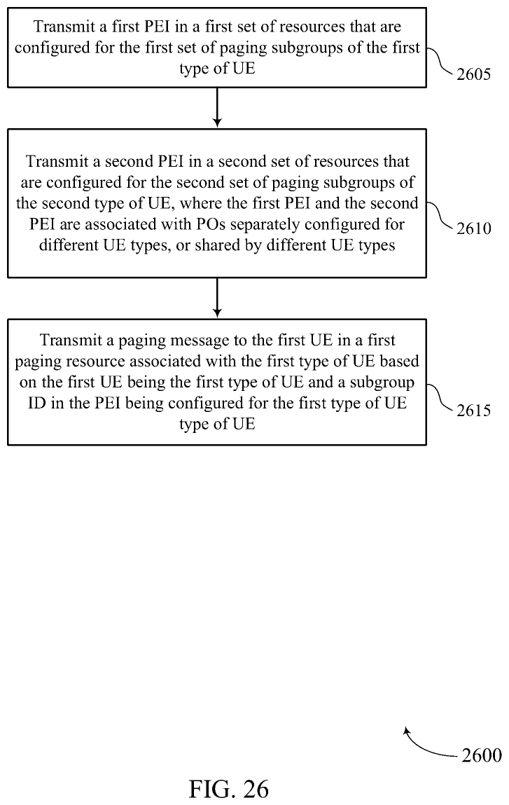

FIG. 26 illustrates a flowchart illustrating a method 2600 that supports paging techniques for wireless devices with mixed capabilities in accordance with one or more aspects of the present disclosure. The operations of the method 2600 may be implemented by a network entity or its components as described herein. For example, the operations of the method 2600 may be performed by a network entity as described with reference to FIGS. 1 through 9 and 14 through 17. In some examples, a network entity may execute a set of instructions to control the functional elements of the network entity to perform the described functions. Additionally, or alternatively, the network entity may perform aspects of the described functions using special-purpose hardware.

At 2605, the method may include transmitting a first PEI in a first set of resources that are configured for the first set of paging subgroups of the first type of UE. The operations of 2605 may be performed in accordance with examples as disclosed herein. In some examples, aspects of the operations of 2605 may be performed by a PEI resource manager 1635 as described with reference to FIG. 16.

At 2610, the method may include transmitting a second PEI in a second set of resources that are configured for the second set of paging subgroups of the second type of UE, where the first PEI and the second PEI are associated with POs separately configured for different UE types, or shared by different UE types. The operations of 2610 may be performed in accordance with examples as disclosed herein. In some examples, aspects of the operations of 2610 may be performed by a PEI resource manager 1635 as described with reference to FIG. 16.

At 2615, the method may include transmitting a paging message to the first UE in a first paging resource associated with the first type of UE based on the first UE being the first type of UE and a subgroup ID in the PEI being configured for the first type of UE type of UE. The operations of 2615 may be performed in accordance with examples as disclosed herein. In some examples, aspects of the operations of 2615 may be performed by a paging manager 1630 as described with reference to FIG. 16.

The following provides an overview of aspects of the present disclosure:

Aspect 1: A method for wireless communications at a first UE, comprising: receiving, in a DRX cycle, a control signaling communication for paging early indication (PEI) associated with a subsequent paging occasion configured for multiple different types of UEs, wherein the PEI comprises one or more paging indication fields that are mapped to one or more subgroups of UEs, the one or more subgroups of UEs including a first set of paging subgroups configured for a first type of UE that supports a first receive bandwidth configuration and a second set of paging subgroups configured for a second type of UE that supports a second receive bandwidth configuration that is different than the first receive bandwidth configuration; and determining whether to monitor the subsequent paging occasion associated with the PEI based at least in part on whether a subgroup identifier (ID) in the PEI is configured for a UE type of the first UE.

Aspect 2: The method of aspect 1, further comprising: receiving, in a subsequent DRX cycle, a subsequent control signaling communication for PEI associated with one or more subsequent paging occasions configured for one or more multiple types of UEs; and skipping monitoring one or more of the subsequent paging occasions associated with the PEI based at least in part on a paging indication field indicating the subgroup ID configured for the UE type of the first UE will not be paged on the subsequent paging occasions associated with the PEI.

Aspect 3: The method of any of aspects 1 through 2, wherein the receiving the control signaling communication comprises: receiving, in the DRX cycle, the PEI that comprises a plurality of PEI fields for multiple UE types which are allowed to monitor paging messages, short messages, system information, other control signaling of a serving network entity, or any combinations thereof.

Aspect 4: The method of aspect 3, wherein each PEI field of the plurality of PEI fields is associated with an identification of a set of different paging subgroup IDs, and indicates if UEs sharing a same subgroup ID will be paged on the subsequent paging occasions associated with the PEI.

Aspect 5: The method of aspect 4, wherein the plurality of PEI fields include one or more of a first PEI field, a second PEI field, or a third PEI field, wherein the first PEI field provides a first set of subgroup IDs that are configured by a core network entity, the second PEI field provides a second set of subgroup IDs that are associated with a UE ID or UE class ID, and the third PEI field provides a third set of subgroup IDs that are configured at a serving cell belonging to a radio area network (RAN) notification area (RNA) of the UE.

Aspect 6: The method of any of aspects 3 through 5, wherein first control signaling further indicates one or more downlink reference signals associated with the one or more subgroups of UEs are activated for UEs in IDLE or INACTIVE states.

Aspect 7: The method of aspect 6, wherein the one or more downlink reference signals include one or more of a tracking reference signal, a non-cell-defining (NCD) synchronization signal block (SSB), a positioning reference signal (PRS), or any combinations thereof.

Aspect 8: The method of aspect 1, wherein the receiving the control signaling communication comprises: receiving a first PEI in a first set of resources that are configured for the first set of paging subgroups of the first type of UE, and receiving a second PEI in a second set of resources that are configured for the second set of paging subgroups of the second type of UE, wherein the first PEI and the second PEI are associated with POs separately configured for different UE types, or shared by different UE types.

Aspect 9: The method of aspect 8, wherein the first set of resources are indicated by a first control resource set (CORESET) configuration associated with the first set of paging subgroups, and the second set of resources are indicated by a second CORESET configuration associated with the second set of paging subgroups.

Aspect 10: The method of any of aspects 8 through 9, wherein the first set of resources are associated with a first search space set that is configured for the first set of paging subgroups, and the second set of resources are associated with a second search space set that is configured for the second set of paging subgroups.

Aspect 11: The method of any of aspects 8 through 10, wherein the first PEI is scrambled with a first group radio network temporary identifier (G-RNTI) associated with the first set of paging subgroups, and wherein a second G-RNTI is used to scramble the second PEI for the second set of paging subgroups.

Aspect 12: The method of any of aspects 8 through 11, wherein the first set of resources are associated with a first DMRS or first waveform configuration that is associated with the first set of paging subgroups, and the second set of resources are associated with a second DMRS or second waveform configuration that is associated with the second set of paging subgroups.

Aspect 13: The method of aspect 1, wherein the receiving the control signaling communication comprises: receiving a PEI that comprises a multi-bit field that indicates which of the first set of paging subgroups, the second set of paging subgroups, or any combinations thereof, will be paged on the subsequent paging occasions associated with the PEI.

Aspect 14: The method of aspect 1, wherein the first UE monitors the paging occasion for a downlink control channel that provides a resource allocation for a shared channel communication that includes a paging message, and wherein the downlink control channel indicates that one or more of the first set of paging subgroups or the second set of paging subgroups is to skip decoding of the shared channel communication, based on the shared channel communication not carrying any paging messages for the first set of paging subgroups or the second set of paging subgroups.

Aspect 15: A method for wireless communications at a network entity, comprising: transmitting to at least a first UE, in a DRX cycle, a control signaling communication for paging early indication (PEI) associated with a subsequent paging occasion configured for multiple different types of UEs, wherein the PEI comprises one or more paging indication fields that are mapped to one or more subgroups of UEs, the one or more subgroups of UEs including a first set of paging subgroups configured for a first type of UE that supports a first receive bandwidth configuration and a second set of paging subgroups configured for a second type of UE that supports a second receive bandwidth configuration that is different than the first receive bandwidth configuration; and transmitting a paging message to the first UE in a first paging resource associated with the first type of UE based at least in part on the first UE being the first type of UE and a subgroup identifier (ID) in the PEI being configured for the first type of UE type of UE.

Aspect 16: The method of aspect 15, further comprising: configuring one or more UEs to skip monitoring one or more subsequent paging occasions associated with the PEI based at least in part on a paging indication field indicating the subgroup ID configured for the first UE type or the second UE type associated with each of the one or more UEs will not be paged on the subsequent paging occasions associated with the PEI.

Aspect 17: The method of any of aspects 15 through 16, wherein the transmitting the control signaling communication comprises: transmitting, in the DRX cycle, the PEI that comprises a plurality of PEI fields for multiple UE types which are allowed to monitor paging messages, short messages, system information, other control signaling of a serving network entity, or any combinations thereof.

Aspect 18: The method of aspect 17, wherein each PEI field of the plurality of PEI fields is associated with an identification of a set of different paging subgroup IDs, and indicates if UEs sharing a same subgroup ID will be paged on the subsequent paging occasions associated with the PEI.

Aspect 19: The method of aspect 18, wherein the plurality of PEI fields include one or more of a first PEI field, a second PEI field, or a third PEI field, wherein the first PEI field provides a first set of subgroup IDs that are configured by a core network entity, the second PEI field provides a second set of subgroup IDs that are associated with a UE ID or UE class ID, and the third PEI field provides a third set of subgroup IDs that are configured at a serving cell belonging to a radio area network (RAN) notification area (RNA) of the UE.

Aspect 20: The method of any of aspects 17 through 19, wherein first control signaling further indicates one or more downlink reference signals associated with the one or more subgroups of UEs are activated for UEs in IDLE or INACTIVE states.

Aspect 21: The method of aspect 20, wherein the one or more downlink reference signals include one or more of a tracking reference signal, a non-cell-defining (NCD) synchronization signal block (SSB), a positioning reference signal (PRS), or any combinations thereof.

Aspect 22: The method of aspect 15, wherein the transmitting the control signaling communication comprises: transmitting a first PEI in a first set of resources that are configured for the first set of paging subgroups of the first type of UE; and transmitting a second PEI in a second set of resources that are configured for the second set of paging subgroups of the second type of UE, wherein the first PEI and the second PEI are associated with POs separately configured for different UE types, or shared by different UE types.

Aspect 23: The method of aspect 22, wherein the first set of resources are indicated by a first control resource set (CORESET) configuration associated with the first set of paging subgroups, and the second set of resources are indicated by a second CORESET configuration associated with the second set of paging subgroups.

Aspect 24: The method of any of aspects 22 through 23, wherein the first set of resources are associated with a first search space set that is configured for the first set of paging subgroups, and the second set of resources are associated with a second search space set that is configured for the second set of paging subgroups.

Aspect 25: The method of any of aspects 22 through 24, wherein the first PEI is scrambled with a first group radio network temporary identifier (G-RNTI) associated with the first set of paging subgroups, and wherein a second G-RNTI is used to scramble the second PEI for the second set of paging subgroups.

Aspect 26: The method of any of aspects 22 through 25, wherein the first set of resources are associated with a first DMRS or first waveform configuration that is associated with the first set of paging subgroups, and the second set of resources are associated with a second DMRS or second waveform configuration that is associated with the second set of paging subgroups.

Aspect 27: The method of aspect 15, wherein the transmitting the control signaling communication comprises: transmitting a PEI that comprises a multi-bit field that indicates which of the first set of paging subgroups, the second set of paging subgroups, or any combinations thereof, will be paged on the subsequent paging occasions associated with the PEI.

Aspect 28: The method of aspect 15, wherein the first UE monitors the paging occasion for a downlink control channel that provides a resource allocation for a shared channel communication that includes a paging message, and wherein the downlink control channel indicates that one or more of the first set of paging subgroups or the second set of paging subgroups is to skip decoding of the shared channel communication, based on the shared channel communication not carrying any paging messages for the first set of paging subgroups or the second set of paging subgroups.

Aspect 29: A first UE, comprising one or more memories storing processor-executable code; and one or more processors coupled with the one or more memories and individually or collectively operable to execute the code to cause the first UE to perform a method of any of aspects 1 through 14.

Aspect 30: A first UE, comprising at least one means for performing a method of any of aspects 1 through 14.

Aspect 31: A non-transitory computer-readable medium storing code for wireless communications at a first UE, the code comprising instructions executable by one or more processors to perform a method of any of aspects 1 through 14.

Aspect 32: A network entity, comprising one or more memories storing processor-executable code; and one or more processors coupled with the one or more memories and individually or collectively operable to execute the code to cause the network entity to perform a method of any of aspects 15 through 28.

Aspect 33: A a network entity, comprising at least one means for performing a method of any of aspects 15 through 28.

Aspect 34: A non-transitory computer-readable medium storing code for wireless communications at a network entity, the code comprising instructions executable by one or more processors to perform a method of any of aspects 15 through 28.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A first user equipment (UE) for wireless communication, comprising:
one or more memories storing processor-executable code; and
one or more processors coupled with the one or more memories and individually or collectively operable to execute the code to cause the first UE to:
receive, in a discontinuous reception (DRX) cycle, a control signaling communication for paging early indication (PEI) associated with a subsequent paging occasion configured for multiple different types of UEs, wherein the PEI comprises one or more paging indication fields that are mapped to one or more subgroups of UEs, the one or more subgroups of UEs including a first set of paging subgroups configured for a first type of UE that supports a first receive bandwidth configuration and a second set of paging subgroups configured for a second type of UE that supports a second receive bandwidth configuration that is different than the first receive bandwidth configuration; and
determine whether to monitor the subsequent paging occasion associated with the PEI based at least in part on whether a subgroup identifier (ID) in the PEI is configured for a UE type of the first UE.

2. The first UE of claim 1, wherein the one or more processors are individually or collectively further operable to execute the code to cause the first UE to:
receive, in a subsequent DRX cycle, a subsequent control signaling communication for PEI associated with one or more subsequent paging occasions configured for one or more multiple types of UEs; and
skip monitoring one or more of the subsequent paging occasions associated with the PEI based at least in part on a paging indication field indicating the subgroup ID configured for the UE type of the first UE will not be paged on the subsequent paging occasions associated with the PEI.

3. The first UE of claim 1, wherein, to receive the control signaling communication, the one or more processors are individually or collectively operable to execute the code to cause the first UE to:
receive, in the DRX cycle, the PEI that comprises a plurality of paging indication fields for multiple UE types which are allowed to monitor paging messages, short messages, system information, other control signaling of a serving network entity, or any combinations thereof.

4. The first UE of claim 3, wherein each paging indication field of the plurality of paging indication fields is associated with an identification of a set of different paging subgroup IDs, and indicates if UEs sharing a same subgroup ID will be paged on the subsequent paging occasions associated with the PEI.

5. The first UE of claim 4, wherein the plurality of paging indication fields include one or more of a first paging indication field, a second paging indication field, or a third paging indication field, wherein the first paging indication field provides a first set of subgroup IDs that are configured by a core network entity, the second paging indication field provides a second set of subgroup IDs that are associated with a UE ID or UE class ID, and the third paging indication field provides a third set of subgroup IDs that are configured at a serving cell belonging to a radio area network (RAN) notification area (RNA) of the UE.

6. The first UE of claim 3, wherein first control signaling further indicates one or more downlink reference signals associated with the one or more subgroups of UEs are activated for UEs in IDLE or INACTIVE states.

7. The first UE of claim 6, wherein the one or more downlink reference signals include one or more of a tracking reference signal, a non-cell-defining (NCD) synchronization signal block (SSB), a positioning reference signal (PRS), or any combinations thereof.

8. The first UE of claim 1, wherein, to receive the control signaling communication, the one or more processors are individually or collectively operable to execute the code to cause the first UE to:
receive a first PEI in a first set of resources that are configured for the first set of paging subgroups of the first type of UE, and receiving a second PEI in a second set of resources that are configured for the second set of paging subgroups of the second type of UE, wherein the first PEI and the second PEI are associated with POs separately configured for different UE types, or shared by different UE types.

9. The first UE of claim 8, wherein the first set of resources are indicated by a first control resource set (CORESET) configuration associated with the first set of paging subgroups, and the second set of resources are indicated by a second CORESET configuration associated with the second set of paging subgroups.

10. The first UE of claim 8, wherein the first set of resources are associated with a first search space set that is configured for the first set of paging subgroups, and the second set of resources are associated with a second search space set that is configured for the second set of paging subgroups.

11. The first UE of claim 8, wherein the first PEI is scrambled with a first group radio network temporary identifier (G-RNTI) associated with the first set of paging subgroups, and wherein a second G-RNTI is used to scramble the second PEI for the second set of paging subgroups.

12. The first UE of claim 8, wherein the first set of resources are associated with a first demodulation reference signal (DMRS) or first waveform configuration that is associated with the first set of paging subgroups, and the second set of resources are associated with a second DMRS or second waveform configuration that is associated with the second set of paging subgroups.

13. The first UE of claim 1, wherein, to receive the control signaling communication, the one or more processors are individually or collectively operable to execute the code to cause the first UE to:
receive a PEI that comprises a multi-bit field that indicates which of the first set of paging subgroups, the second set of paging subgroups, or any combinations thereof, will be paged on the subsequent paging occasions associated with the PEI.

14. The first UE of claim 1, wherein the first UE monitors the paging occasion for a downlink control channel that provides a resource allocation for a shared channel communication that includes a paging message, and wherein the downlink control channel indicates that one or more of the first set of paging subgroups or the second set of paging subgroups is to skip decoding of the shared channel communication, based on the shared channel communication not carrying any paging messages for the first set of paging subgroups or the second set of paging subgroups.

15. (canceled)

16. (canceled)

17. (canceled)

18. (canceled)

19. (canceled)

20. (canceled)

21. (canceled)

22. (canceled)

23. (canceled)

24. A method for wireless communication by a first user equipment (UE), comprising:
receiving, in a discontinuous reception (DRX) cycle, a control signaling communication for paging early indication (PEI) associated with a subsequent paging occasion configured for multiple different types of UEs, wherein the PEI comprises one or more paging indication fields that are mapped to one or more subgroups of UEs, the one or more subgroups of UEs including a first set of paging subgroups configured for a first type of UE that supports a first receive bandwidth configuration and a second set of paging subgroups configured for a second type of UE that supports a second receive bandwidth configuration that is different than the first receive bandwidth configuration; and
determining whether to monitor the subsequent paging occasion associated with the PEI based at least in part on whether a subgroup identifier (ID) in the PEI is configured for a UE type of the first UE.

25. The method of claim 24, further comprising:
receiving, in a subsequent DRX cycle, a subsequent control signaling communication for PEI associated with one or more subsequent paging occasions configured for one or more multiple types of UEs; and
skipping monitoring one or more of the subsequent paging occasions associated with the PEI based at least in part on a paging indication field indicating the subgroup ID configured for the UE type of the first UE will not be paged on the subsequent paging occasions associated with the PEI.

26. The method of claim 24, wherein the receiving the control signaling communication comprises:
receiving, in the DRX cycle, the PEI that comprises a plurality of paging indication fields for multiple UE types which are allowed to monitor paging messages, short messages, system information, other control signaling of a serving network entity, or any combinations thereof.

27. The method of claim 24, wherein the receiving the control signaling communication comprises:
receiving a first PEI in a first set of resources that are configured for the first set of paging subgroups of the first type of UE, and receiving a second PEI in a second set of resources that are configured for the second set of paging subgroups of the second type of UE, wherein the first PEI and the second PEI are associated with POs separately configured for different UE types, or shared by different UE types.

28. (canceled)

29. (canceled)

30. (canceled)

31. The method of claim 26, wherein each paging indication field of the plurality of paging indication fields is associated with an identification of a set of different paging subgroup IDs, and indicates if UEs sharing a same subgroup ID will be paged on the subsequent paging occasions associated with the PEI.

32. The method of claim 31, wherein the plurality of paging indication fields include one or more of a first paging indication field, a second paging indication field, or a third paging indication field, wherein the first paging indication field provides a first set of subgroup IDs that are configured by a core network entity, the second paging indication field provides a second set of subgroup IDs that are associated with a UE ID or UE class ID, and the third paging indication field provides a third set of subgroup IDs that are configured at a serving cell belonging to a radio area network (RAN) notification area (RNA) of the UE.
